(19) United States
(12) Patent Application Publication
(10) Pub. No.: US 2025/0189727 A1
(43) Pub. Date: Jun. 12, 2025

(54) TERAHERTZ WAVEGUIDE SWITCHES

(71) Applicant: California Institute of Technology, Pasadena, CA (US)

(72) Inventors: Sofia Rahiminejad, Pasadena, CA (US); Mina Rais-Zadeh, Pasadena, CA (US); Cecile D. Jung-Kubiak, Pasadena (FR); Goutam Chattopadhyay, Pasadena, CA (US); Robert H. Lin, Chino, CA (US); Sven L. Van Berkel, Pasadena, CA (US); Subash Khanal, Pasadena, CA (US)

(73) Assignee: California Institute of Technology, Pasadena, CA (US)

(21) Appl. No.: 18/889,121

(22) Filed: Sep. 18, 2024

Related U.S. Application Data
(63) Continuation-in-part of application No. 17/845,762, filed on Jun. 21, 2022, now Pat. No. 12,113,259.
(60) Provisional application No. 63/213,122, filed on Jun. 21, 2021.

(51) Int. Cl. G02B 6/35

(52) U.S. Cl. CPC G02B 6/3584; G02B 6/3578

(57) ABSTRACT

A MEMS switch that can be integrated with waveguides to switch transmission of terahertz electromagnetic waves between the waveguides.

### CROSS REFERENCE TO RELATED APPLICATIONS

This application is a continuation in part under 35 U.S.C. § 120 of U.S. Utility Patent application Ser. No. 17/845,762, filed Jun. 21, 2022, by Goutam Chattopadhyay, Robert H. Lin, Sven L. Van Berkel and Sofia Rahiminejad, entitled “TERAHERTZ WAVEGUIDE SWITCHES,” Docket No. 176.0191-US-U1, which application claims the benefit under 35 U.S.C. Section 119(e) of co-pending and commonly-assigned U.S. provisional patent application Ser. No. 63/213,122 filed on Jun. 21, 2021, by Goutam Chattopadhyay, Robert H. Lin, and Sven L. Van Berkel, entitled “TERAHERTZ WAVEGUIDE SWITCHES USING PIEZO ELECTRIC MOTORS,” client reference CIT-8665-P, all of which applications are incorporated by reference herein.

### STATEMENT REGARDING FEDERALLY SPONSORED RESEARCH AND DEVELOPMENT

This invention was made with government support under Grant No. 80NMO0018D0004 awarded by NASA (JPL). The government has certain rights in the invention.

### BACKGROUND OF THE INVENTION

### 1. Field of the Invention

This invention relates to low loss sub-millimeter wave switches and methods of making the same.

### 2. Description of the Related Art

Remote-sensing systems utilize a calibration in order to obtain high-fidelity data. Typical microwave measurement systems use a Dicke-switch type of calibration where a low-loss switch connects the receiving system alternatingly to the antenna and a load that generates a precisely known amount of Johnson noise power [1]. Such single-pole dual-throw (SPDT) switches also find application in transceivers or dual-band systems. At microwave and millimeter-wave (mm-wave) frequencies, low-loss SPDT switches are readily available [2]. Typical switching solutions are transistor-, diode- and Microelectromechanical systems (MEMS)-based using integrated circuit (IC) technologies [3]-[6], or waveguide integrated PIN diodes [7].

At sub-mm-wave frequencies, spectrometers and radiometers measuring molecular absorption and rotational lines for earth and planetary science utilize a high-precision calibration mechanism. Due to the non-availability of low-loss switches at sub-mm wave frequencies, bulky and power-hungry motors with flip mirrors are typically used to perform the function of the low-loss switch by re-pointing the antenna to the cold sky.

A waveguide integrated solution for RF front-end components is preferred due to its the low insertion loss, high power handling capabilities and a degraded IC-technology performance. RF-MEMS waveguide-based single-pole single-throw (SPST, ON/OFF) switches, fabricated using silicon micro-machining techniques, have been developed as a preliminary step towards SPDT switching [8], [9]. In [9], the 500 GHz-750 GHz switch used a MEMS reconfigurable surface whereas the switch presented in [8] used a MEMS controlled septum. All of these MEMS waveguide switches require relatively high power for actuation and mechanical and electrical contact between waveguide walls to switch between states, thus increasing the risk of stiction and failure.

What is needed then, are more reliable, low power, and robust switches for terahertz devices. The present disclosure satisfies this need.

### SUMMARY OF THE INVENTION

A switch comprising an Micro-Electro-Mechanical System (MEMS) device comprising an actuator, the actuator comprising a motor coupled to a switching body and wherein the switching body comprises a connector waveguide. The switching body is placed on a rotating arm that moves between two positions (“off” and “on” positions or two positions that connect different pairs of waveguides). The arms movement is controlled by a rotating MEMS motor that can rotate, for example, ±4.5° at 70 V.

The connector waveguide comprises a first connector port and a second connector port spaced by a length of the connector waveguide such that the first connector port couples to a first port of a first waveguide and the second connector port couples to a second port of a second waveguide through an air gap when the motor rotates the switching body to an on position.

The waveguides are configured and dimensioned to guide an electromagnetic wave having a frequency in a range of 100 gigahertz (GHz) to 1000 terahertz (THz).

The connector waveguide is surrounded by an electromagnetic bandgap (EBG) surface. used to isolate the electromagnetic wave without mechanical or electrical contact.

The switch is fabricated using silicon micromachining and is designed to be in-plane with the connecting waveguides. This allows it to be implemented into a silicon micromachined waveguide network.

In one embodiment, the waveguide switch has a measured insertion loss less than 2.5 dB and an isolation larger than 30 dB between 550-750 GHz. Since the electromagnetic wave can be routed with the EBG surface instead of needing electrical or mechanical contact, the MEMS waveguide switch can operate without the need for mechanical contact and avoids common MEMS switch issues such as stiction between the switch and its ports.

### BRIEF DESCRIPTION OF THE DRAWINGS

Referring now to the drawings in which like reference numbers represent corresponding parts throughout:

FIGS. 1A-1D. Piezo-electric waveguide switch. FIG. 1A illustrates a full device. FIG. 1B illustrates the split-block, showing the waveguides of the single pole (P) port and the double throw (T1 and T2) positions. FIG. 1C illustrates waveguide switching interface with EBG structure. FIG. 1D is a schematic representation of the SDPT switch.

FIGS. 2A-2B. Simulated transmission and reflection for a single waveguide, embedded in two PEC blocks separated by a gap as indicated in the top of the figure. The simulated gaps are g=10, 20, 30, 40, 50 μm FIG. 2A: No EBG is present. FIG. 2B: EBG is present.

FIGS. 3A-3C. Dimensions of EBG structure and waveguide terminals. FIG. 3A is a schematic side-view of the switching blade in the presence of the waveguide block. FIG. 3B is a schematic top-view of the waveguide block containing the waveguide terminals and EBG structure. FIG. 3C is a schematic side-view indicating how the switching blade and waveguide block are separated by Teflon spacers.

FIG. 4A-4C. Simulated reflections (FIG. 4A), transmission (FIG. 4B) and isolation (FIG. 4C) of the switch interface, as function of the gap height g.

FIGS. 5A-5C. Different components and assembly stages of the piezo switch, wherein FIG. 5A shows waveguide routing, FIG. 5B shows switching directions, and FIG. 5C shows alignment pins and slots.

FIGS. 6A-6C. Simulated switch performance as function of a switch blade mis-alignment Δy as indicated in FIG. 5B. The gap height is g=50 μm and a conductivity of σ=4.1·10⁷ S/m is assumed, wherein FIG. 6A shows reflections, FIG. 6B shows transmission and FIG. 6C shows isolation.

FIG. 7. Measurement setup. The common port and an output port are connected to a VNA whereas the other output port is terminated with a waveguide load.

FIGS. 8A-8C. VNA measurements of the switch. A S21 link is established between the common port P and port T2 and a load is connected to T1. Shown are measurements before (solid lines) and after (dotted lines) performing 1 million switch actions, compared to the simulations (black), for reflections (FIG. 8A), transmission (FIG. 8B) and isolation (FIG. 8C).

FIGS. 9A-9B. Reflections (FIG. 9A) and transmission (FIG. 9B) measurements during durability cycling. The measurements are done the first 18,000 switching actions and the last 15,000 switching actions. A total of 1 million switching actions are performed.

FIG. 10. Target position and position error during a single switch action where the switch is moved from T₁ to T₂. The final positioning error, when the switch stops its motion, is defined as Δ.

FIG. 11. Histogram of position error for port 1 (FIG. 11A) and port 2 (FIG. 11B). The mean absolute position error is μ(|Δ|)=1.57 μm and 1.97 μm for port 1 and 2 respectively. A total of 1M switch actions is performed and the position error at each port location, Δ as shown in FIG. 10, is recorded every 10th switching cycle.

FIG. 12. Receiver system comprising a metallic switch blade according to a second example.

FIG. 13. Schematic illustrating waveguide and switch blade dimensions of the second example.

FIG. 14 illustrates a piezoelectric motor driving the metallic switch blade of the second example.

FIG. 15. Simulation showing the transmission and loss characteristics of the switch comprising metallic switch blade of the second example.

FIG. 16A illustrates the U-bend waveguide is placed on a rotating disc in its natural state. FIG. 16B shows that when actuated, the disc rotates θ=4.5° and either connect port 1-2 or port 1-3. The surrounding pins create an EBG surface and can thus allow the wave to go from one port through the U-bend to the next port without leaking to the sides, even though there is an air gap.

FIG. 17A is a scanning electron microscope (SEM) image of the four springs attached to center of rotation.

FIG. 17B is a Microscope image view of the full device seen from the top while actuated.

FIG. 17C is an SEM image of the waveguide section, seen from the top.

FIG. 17D is an SEM image of the waveguide section seen from the bottom.

FIG. 17E is a Microscope image of the center line and Vernier lines 1606 from the top, when no voltage is applied, 0°.

FIG. 17F is a Microscope image of the center line and Vernier lines from the top, when voltage is applied, 4.5°. The Vernier lines go from −5° to +5°.

FIG. 17G is a microscope image close-up of the comb-drive displacement when fully actuated.

FIG. 18. Dispersion plot of the unit cell with up to 5 modes, displaying a stop-band between 500 and 800 GHz.

FIG. 19: Front view image of the waveguide disc. Where the U-bend waveguide (FIG. 1) is faced down towards the bottom surface.

FIG. 20A. Schematic view of the MEMS motor design with the three two-sided comb-drives, the waveguide switch and the counter weight.

FIG. 20B. Close-up of the cross spring design in the center of the design.

FIG. 20C. Close-up of the serpentine design of the spring distance between the fingers.

FIG. 21: The voltage needed to rotate the MEMS motor θ degrees, based on simulated forces and Eq. 5 and the spring parameters in Table II.

FIG. 22A: Top-view drawing of the contactless rotating MEMS waveguide switch inside the block design. The MEMS waveguide switch is semi-transparent in order to show the Ubend waveguide that is facing the bottom block. The milled waveguide paths are highlighted in dark grey.

FIG. 22B. Schematic of the MEMS waveguide switch housed in a silicon or silicon on insulator wafer comprising the waveguides patterned in the silicon or silicon on insulator wafer (e.g., silicon ridge waveguide with oxide cladding). In one embodiment, the central waveguide is connected to a receiver, one of the other waveguides is connected to an antenna, and the remaining waveguide is connected to a reference load. Waveguide lengths to the antenna, receiver, and load can be made much shorter in silicon than in metal, thereby reducing losses.

FIG. 23A. Simulated transmission when port 1 and 2 are connected (S₂₁, blue solid) and when port 1 and 3 are connected (S₃₁, red dotted). FIG. 23B Reflection at port 1 (S₁₁, orange dashed) and isolation during both when connecting 1-2 (S₃₁, red dotted) and 1-3 (S₂₁, blue solid). FIG. 23C Simulated transmission (S₂₁ blue line), reflection (S₁₁ red line) and isolation (S₁₃ yellow line) for only the waveguide disc (no waveguide losses are included) and for the embodiment including the counterweight and 390 micron handle layer thickness.

FIGS. 24A-24C: Simulated comparison of the lighter waveguide disc design with and without the three long connecting waveguide ports (FIG. 7). A 10 μm air gap and a 5 μm separation was used.

FIGS. 25A-25C: S-parameter simulations of the light waveguide disc only for 5 μm separation and different air gaps, 5 μm, 10 μm, 20 μm and 30 μm.

FIGS. 26A-26C: S-parameter simulations of the light waveguide disc only for 10 μm air gap and different separations, 5 μm, 10 μm, 15 μm and 20 μm, underneath the disc.

FIG. 27A-27E: Process flow for manufacturing the rotating contactless MEMS waveguide switch, wherein FIG. 27A shows structure, FIG. 27B shows the back side of the wafer is patterned and etched 5 μm to define the spacers that allow for free rotation of the switch, FIG. 27C shows the front side of the wafer is patterned and etched using a deep reactive ion etch (DRIE) process, FIG. 27D shows the back side of the wafer is also patterned and etched using a silicon DRIE process, and FIG. 19E shows the BOX layer is removed from the back using dry etching and the key parts are sputtered with Ti/Au to make electrical contacts for the application of an actuation voltage.

FIGS. 28A-28B Scanning Electron Microscope (SEM) images of a) the cross serpentine springs and b) the top view of the waveguide switch.

FIGS. 29A-29B Photographs of the fully fabricated silicon contactless rotating MEMS waveguide switch placed inside the bottom half of the milled gold-plated measurement block. losses are higher when comparing to the simulations of only the waveguide disc (FIG. 18). However, when adding the long waveguide paths of the measurement block, a 10 μm air gap and 10 μseparation underneath the disc (Black lines in FIG. 31), the measurements agree well with simulations. The increased separation underneath the disc was needed to avoid the disc getting stuck on unwanted bumps of the milled block.

FIG. 30A Measured S₂₁ for different applied voltages (for embodiment without the counterweight), together with simulated S₂₁ (black dashed line) when the block is split at the top and has a 5 μm gap. FIG. 30B is a simulated S₂₁ when connecting Ports 1 and 2 for an ideal block without a split (blue), with a split at the top of the waveguide (purple), and when split is at the middle (orange).

FIGS. 31A-31D: S-parameter measurements of the fully fabricated MEMS switch with counterweight inside the milled measurement block together with simulations of the light design with 10 μm air gap and separation underneath the disc. FIG. 31A Close-up view of the measured S₂₁ in both directions, Clockwise (CW) and Counterclockwise (CCW). FIG. 31B Measured transmission S₂₁ for both the OFF position (neutral 0°) and ON position. FIG. 31C Measured reflection S₁₁, for both directions, CW and CCW. FIG. 31D measured isolation S₁₃ for both directions, CW and CCW.

FIG. 32: Measured transmission (S₁₂) at 635 GHz for different applied voltages. controlled Bias control, which alternated the applied voltage for both sides between 90 V and 0 V at a frequency of 0.5 Hz.

FIG. 33. Example application including a switch according to embodiments described herein.

FIG. 34. Example receiver systems comprising a switch according to embodiments described herein.

FIG. 35 is a flowchart illustrating a method of making a waveguide integrated switch.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized, and structural changes may be made without departing from the scope of the present invention.

### Technical Description

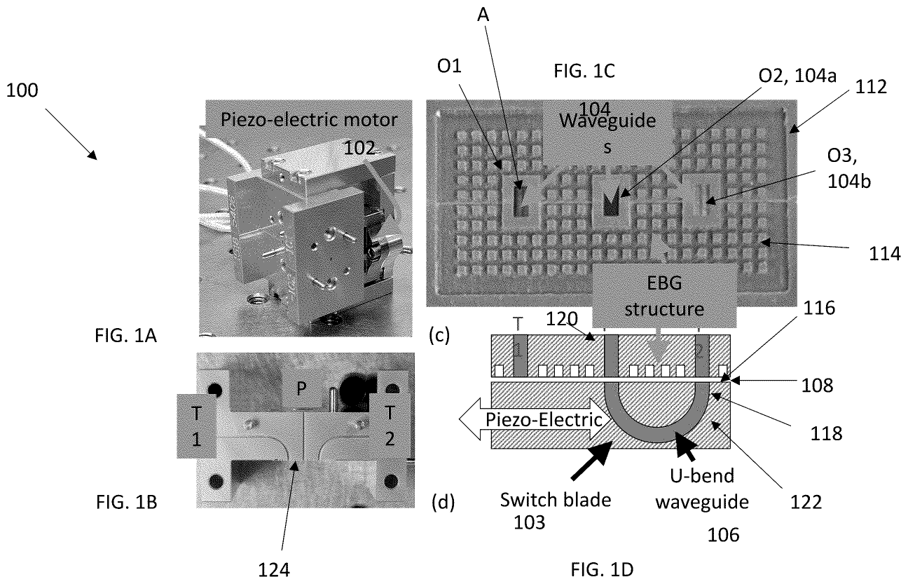

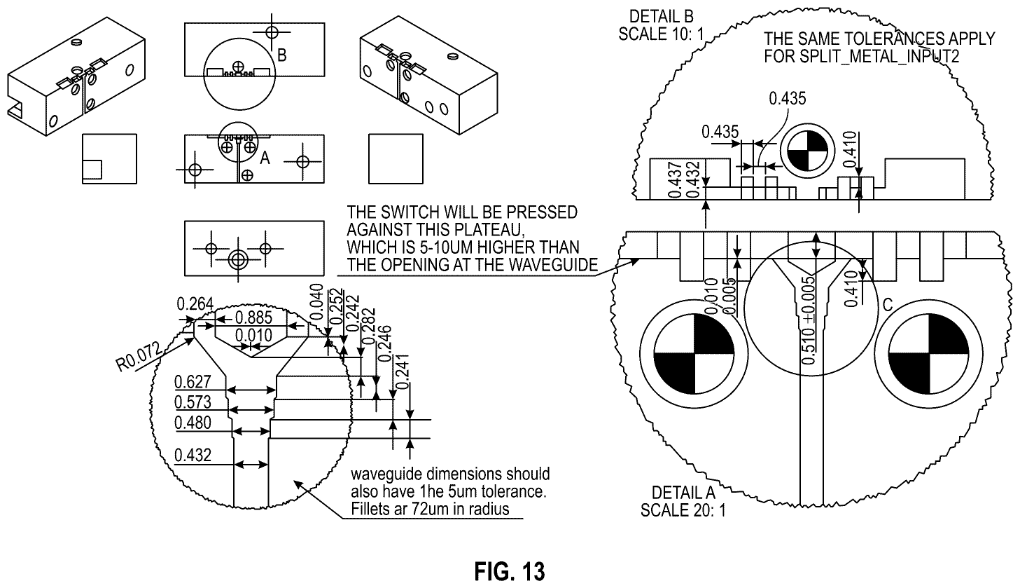

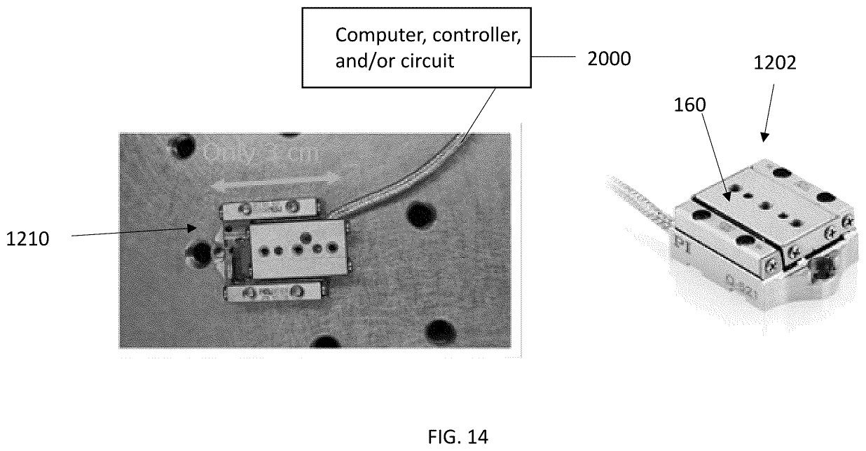

FIGS. 1-17 illustrate example implementations of a waveguide integrated switch 100, 1200, 1600 comprising an actuator 102, 1202, 1602 comprising a switching body 103, 1203, 1604 coupled to one or more waveguides 104, 1204, 1608. The actuator 102, 1602 actuates the switching body 103, 1604 to open or close transmission of an electromagnetic wave 107 to the one or more waveguides. Each of the waveguides 1608, 104, 1204 are configured and dimensioned to guide the electromagnetic wave having a frequency in a range of 100 gigahertz (GHz) to 1000 terahertz (THz). In one or more examples, the switch can position the switching body relative to the waveguides with nanometer accuracy (or with an accuracy in a range of 1-10 nanometers or 1 nm-1000 microns). In one or more examples, a position measuring device 1606, 1210, 150 is coupled to the switching body 103, 1203, 1604 or a stage moving the switching body, for measuring a position of the switching body relative to the waveguide with nanometer or micrometer resolution/accuracy/precision. Example actuators include, but are not limited to, a piezoelectric motor or a MEMS motor [10], as discussed in the following examples (first embodiment, second embodiment, and third embodiment).

### First Embodiment Comprising Position Feedback and Piezoelectric Motor Drive

### Device Structure

FIGS. 1A-1D illustrate a waveguide integrated switch according to a first example, wherein an input waveguide (i.e. single pole P comprising opening O1) is switchably connected to one of the two output waveguides (dual throw T1 and T2 comprising openings O2 and O3) via a piezo-electric controlled switching blade, element, or body 102 that contains a connector waveguide (U-bend waveguide 106) to direct the signal to the desired port. A gap 108 between the switching blade and the waveguide block 112 ensures no metal-on-metal contact between the switching blade and switch block to minimize friction. The U-bend waveguide comprises an input 110 (e.g., opening) and an output 112 (e.g., opening) that can be positioned by the motor for coupling terminals P, T1, and T2.

In the example shown, the metal waveguide block 112 comprises at least a first waveguide 104, 104a and a second waveguide 104, 104b and the metal waveguide block has a first metal surface 114 comprising an electromagnetic bandgap surface surrounding a first opening O1 spaced from a second opening O1 along a linear switching direction. The first opening comprises a first terminal T2 (first input to, or a first output from) the first waveguide; and the second opening O2 comprises a second terminal P (second input to, or a second output from) the second waveguide 104.

The metal switching element 103 comprises a metal piece comprising a second metal surface 116 including an input 118 to the connector waveguide separated (along the linear switching direction) from an output 120 from the connector waveguide.

The actuator 102 comprising the piezoelectric motor moves the connector waveguide 106 between:
a first position 122, coupling (via the gap 108) the input 118 (of the connector waveguide) to the first waveguide 104a (having port P or opening O2) and the output 120 (of the connector waveguide) to the second waveguide having port T2 (or opening O3), so that the electromagnetic wave is transmitted from the first waveguide to the second waveguide via the connector waveguide; and
a second position 124, de-coupling the input 118 from the first waveguide and the output 120 from the second waveguide.

### Simulations

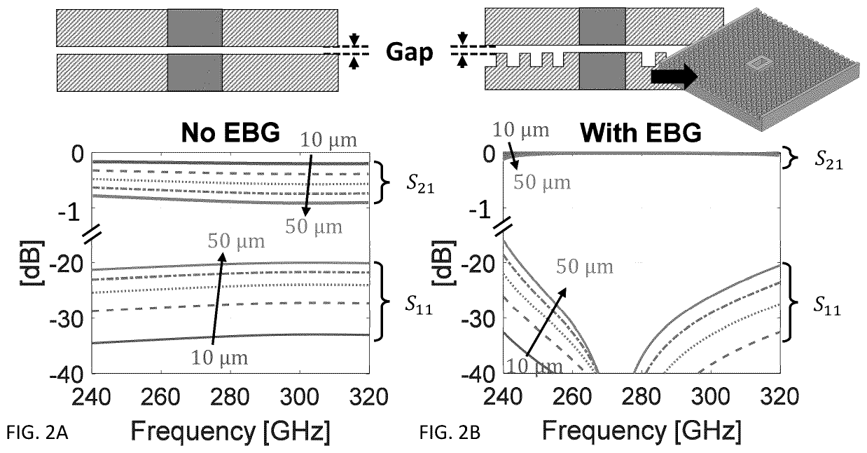

FIG. 2A shows a WR-3.4 waveguide integrated in two perfectly electrically conducting (PEC) waveguide blocks with smooth surfaces, separated by the small gap. FIG. 2(a) shows the reflections and transmission from one block to the other is shown as function of the gap between two waveguide blocks. For a 50 μm gap, a leakage of 1 dB occurs into parallel plate modes and the reflections increase to −20 dB.

Suppression of unwanted radiation, in a single direction, may be achieved by imposing anistropic high-impedance boundary conditions formed by soft- and hard surfaces [11]. EBG structures, similar to soft surfaces, can create a high-impedance boundary condition in two dimensions [12]. An EBG structure, in the form of a bed of square nails placed in a square lattice between two parallel plates, has been used to realize ridge gap waveguides, where parallel plate modes are suppressed and a local waveguide mode is supported [13]. This type of EBG structure also has been identified to be effective to realize contactless SPST waveguide switches [14]. This technology can also be used to realize a SPDT switch. General design rules for bandgap bandwidth, i.e. the bandwidth in which the excitation of parallel plate modes are prohibited are described in [15]. The dimensions of the EBG structure, in the presence of the waveguide, are optimized using full-wave simulations in CST Microwave Studio. The inset of FIG. 2(b) illustrates simulation of one waveguide with 8 nails on either side of the waveguide. The targeted frequency band for optimal operation is between 260 GHz and 280 GHz using an optimization goal of S₁₁<−30 dB.

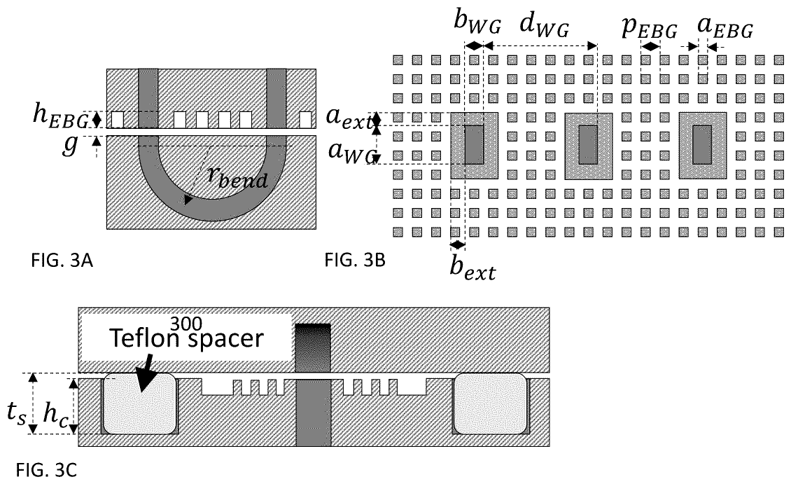

TABLE I
Dimensions of the switch interface and EBG as depicted in
Fig. 3. The wavelength, λ₀, is defined at 270 GHz

| Param. | Value [mm] (λ₀) | Param. | Value [mm] (λ₀) |
|---|---|---|---|
| a_{WG} | 0.864 | b_{WG} | 0.432 |
| aₑₓₜ | 0.297 | bₑₓₜ | 0.305 |
| d_{WG} | 2.5 | τ_{bend} | 1.25 |
| tₛ | 2_{-0.01}^{+0.02} | h_{c} | 1.97_{-0.01}^{+0.01} |
| a_{EBG} | 0.208 | p_{EBG} | 0.417 |
| | (0.1872) | | (0.3753) |
| h_{EBG} | 0.278 | g | 10 μ-60 μ |
| | (0.25) | | (0.009-0.054) |

Table 1 tabulates the optimized dimensions (see FIG. 3(a) and (b)) with the EBG dimensions normalized to the wavelength for the frequency of 270 GHz. The waveguide dimensions a_{WG} and b_{WG} are standard WR-3.4 definitions.

FIG. 2B shows the transmission and reflections of the waveguide in the presence of the optimized EBG and as function of gap height, showing no leakage can be observed in the full frequency band and the reflections lower than −30 dB in the target frequency band.

The three waveguide terminals, T₁, P, T₂, should be as close as possible (as illustrated by d_{WG} in FIG. 3B) to minimize ohmic dissipation losses in the U-bend waveguide and maximize the switching speed of the piezo-electric motor. However, a sufficient number of EBG periods should remain in between each terminal to maintain EBG functionality. We discovered that a small number (three nails) surrounding each waveguide is sufficient to ensure high isolation and low leakage, enabling waveguide separation and the required travel distance of d_{WG}=2.5 mm for the piezo-electric motor.

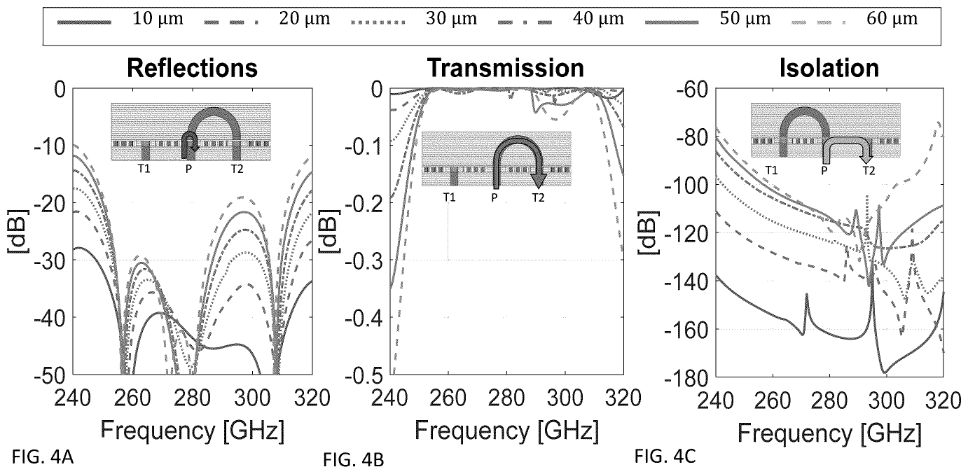

FIG. 4 plots the simulated reflections, transmission and isolation of the full switching interface as function gap height, g. As compared to the single waveguide simulations plotted in FIG. 2B, a slightly increased resonant behavior can be identified in the reflection curves. However, the −20 dB and −30 dB bandwidths are maintained if the gap is smaller than g<60 μm. An extremely low isolation (<−80 dB) between the input terminal P and non-connected output terminal Tis observed. Consequently, the SPDT waveguide switch is also very suitable for transceiver applications for which a high isolation is typically required to avoid receiver saturation.

FIG. 3C illustrates a Teflon spacer 300 inserted in high precision cavities fabricated in the waveguide block and used to ensure that the gap 108 height is not larger than 60 μm. The spacer 300 is required to avoid any metal-on-metal friction between the metallic switch block and waveguide block.

### Example Fabrication and Assembly

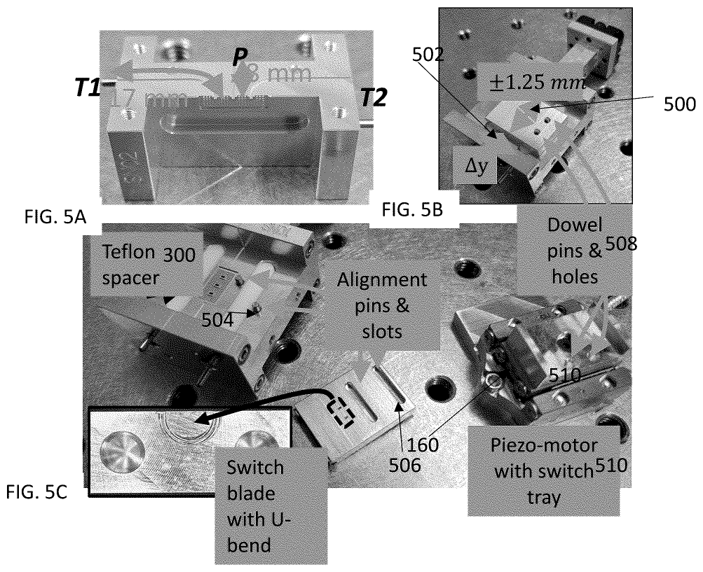

FIGS. 5A-5C illustrate the assembly of the fully metal machined split block with Teflon spacers and the piezo-electric motor 102 [16] to form a robust and low-loss waveguide integrated switch. FIG. 5A illustrates re-direction of the three waveguide terminals to different sides of the waveguide block for routing to different components of a THz application utilizing the switch.

FIG. 5B illustrates the allowed switching path in the switching direction 500 and the alignment error (Δy) of the switch blade in the non-switching direction 502. FIG. 5C illustrates alignment pins 504 and slots 506 used to define the switching path and reduce or minimize, or otherwise configure the alignment error Δy. The alignment pins 504 and slots 506 are placed with a ±10 μm position tolerance with respect to the positions of the waveguide terminals. Precision shims may be used to fix the motor assembly to the waveguide block while ensuring free movement of the switch blade over the switching path that is defined by the two pins and slots.

FIG. 5C further illustrates the switching element, body (e.g., blade) is connected to the piezo-motor by means of dowel pins 508 that fit into a switch tray 510 screwed on the motor 102 stage 160. FIG. 5D shows the motor is screwed on a metal plate attached to the sides of the waveguide block via two additional metal plates.

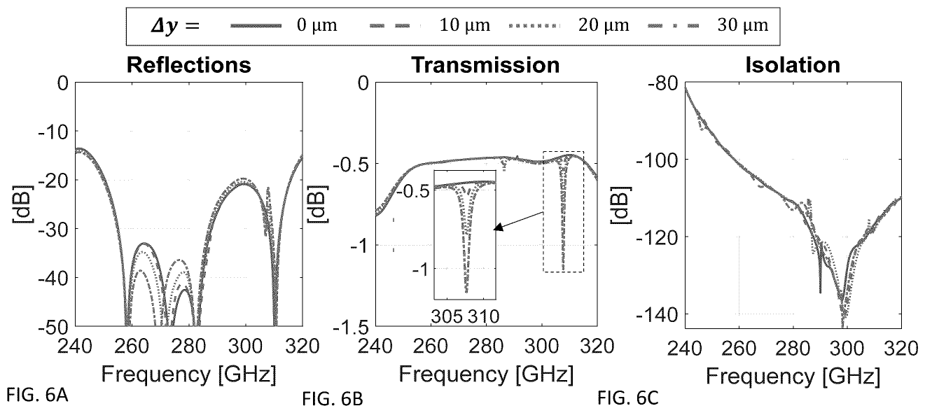

FIGS. 6A-C plot the reflections, transmissions, and isolation evaluating the switch performance, taking into account the full waveguide paths, as function of the switch blade alignment error Δy and for a gap height of g=50 μm and conductivity σ=4.1·10⁷ S/m. FIGS. 6A-6C demonstrate no significant effect in the reflections and isolation can be observed for appropriately minimized alignment errors. However, as shown in FIGS. 6(a)-(c), excitation of a resonant cavity mode between the switch blade 103 and waveguide block starts to appear in the transmission plot for a position error of Δy=30 μm at a frequency of 308 GHz. A reduction in transmission of less than 0.3 dB is expected for an achievable alignment accuracy of 20 μm. Switch losses of less than 0.5 dB are governed by the 17 mm long waveguides.

### Characterization Measurements of the First Embodiment

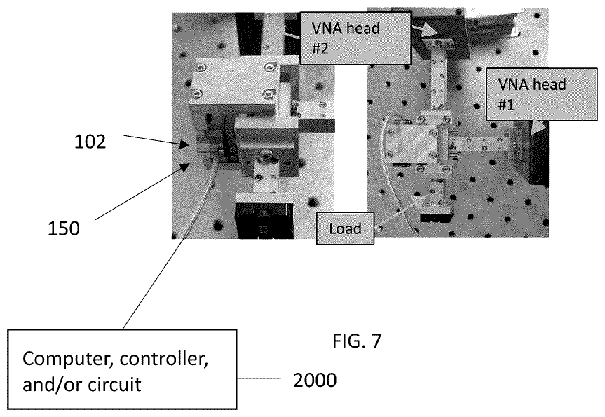

The piezo-switch of FIG. 1 and FIG. 5 was characterized by measurement using a Keysight PNA-X vector network analyzer (VNA) and WR-3.4 frequency extenders from VDI. FIG. 7 illustrates connection of the VNA to the waveguide integrated switch with an S₂₁-link between the common port and one of the output waveguide ports and the other output waveguide port terminated by a waveguide load. The piezo-electric motor is connected to a desktop computer via a controller.

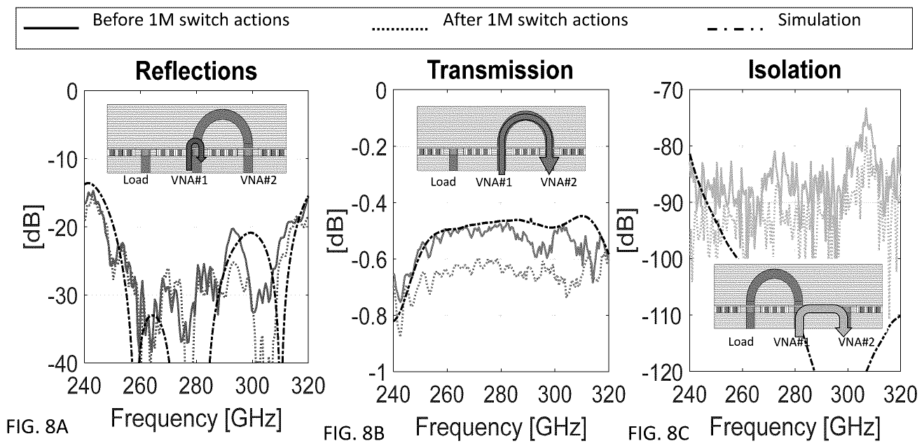

FIG. 8 plots the measured reflections, transmission and isolation (solid lines) of the piezo-switch solid lines in comparison with the simulation (black lines) for g=50 μm, Δy=0 μm). The isolation is measured as the S₂₁-link when the switch is directed to the waveguide load. The measured data shows good agreement between the measurements and simulations. Moreover, the measured reflections in the target frequency bandwidth for optimal operation (260 GHz to 280 GHz) are substantially below −25 dB, thereby enabling high-fidelity calibrations.

The measured date further shows the waveguide integrated switch is characterized by a <−20 dB reflection bandwidth from 248 GHz to 312 GHz. FIG. 8(b) (a transmission plot) shows a measured insertion loss less than 0.6 dB. The undesirable excitation of a resonant cavity mode at 308 GHz (see previous section) cannot be identified in the transmission plot, confirming a good alignment of the switch blade in the non-switching direction, Δy.

The data further shows the isolation is measured to be lower −75 dB and is potentially limited to the dynamic range of the measurement setup and the quality of the calibration.

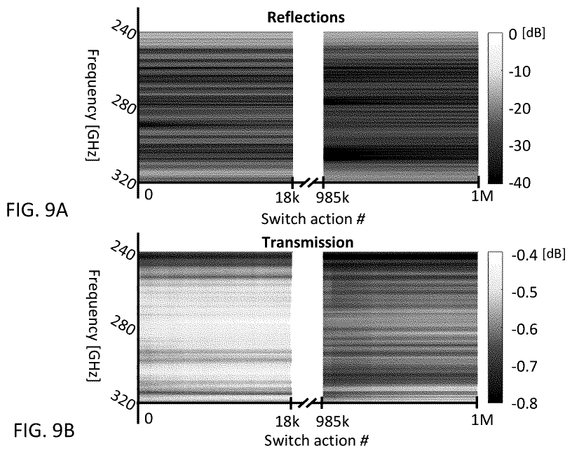

Durability of the piezo-switch was characterized by performing a total of one million switching actions. In order to quantify any potential performance degradation, the switch was connected to the VNA for the first 18000 switching actions and the last 15000 switching actions and reflections and transmission were recorded for every tenth switching cycle. The measurements in FIGS. 8 and 9 show the switch performance after one million switching actions (dotted lines) show the performance of the switch is extremely stable and constant over time. Only minor differences can be identified in the reflections and isolation as a function of the number of switching actions. For example, the transmission reduced by approximately 0.15 dB, probably due to the accumulation of dirt and dust in the waveguide terminals while switching.

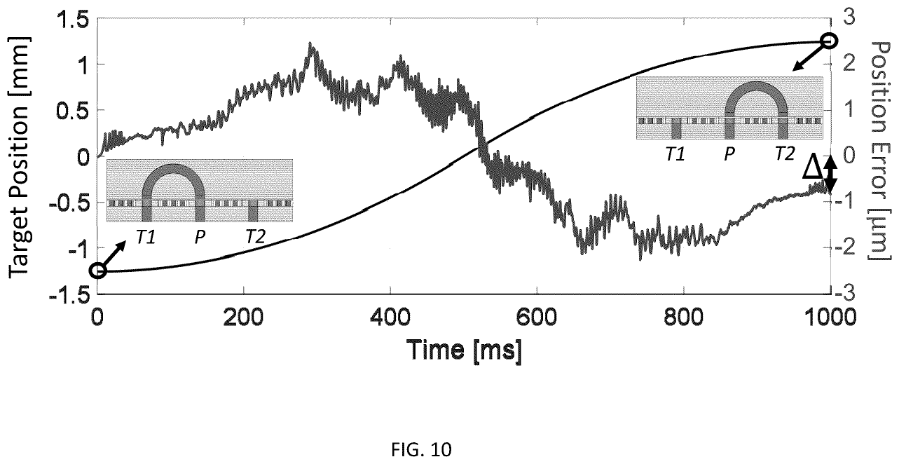

The piezo-electric motor [16] is coupled to a non-contact measuring optical linear encoder 150 (see FIGS. 7 and [16]) configured to provide feedback of the switch position and position error with respect to a target position. FIG. 10 illustrates a typical switch action, in terms of target position and position error as function of time The motor is capable of achieving a top velocity of 6 mm/s and takes one second to perform a single switch action. This switching speed is sufficient for calibration purposes and is a significant improvement with respect to heavy flip mirrors. The targeted position is shown by the black curve and left y-axis whereas the position error, i.e. the deviation of the actual position with respect to the target position, is shown by the red curve and right y-axis. The final position error when the motor has stopped its motion (Δ in FIG. 10) is recorded every 10th switching cycle during a total of one million (1M) switching actions for both switching positions.

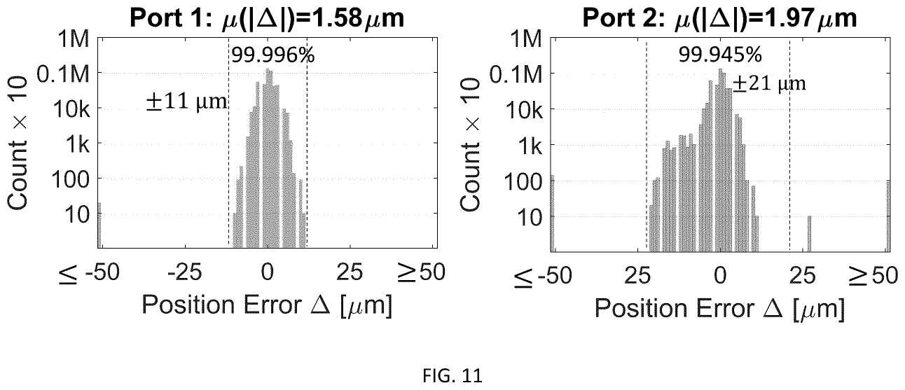

FIG. 11 is a histogram plotting the final position error Δ¹ for both ports. When switching to port 1, the mean absolute positioning error μ(|Δ|)=1.58 μm and 99.996% of the recordings are within a range of Δ=±11 μm. A position error of Δ≤−50 μm was counted twice (0.004% of the total switch cycles). Possible explanations for such switching failures include the instantaneous positioning error exceeding the prescribed positioning error threshold, due to an increased friction or misalignment of the switch blade. In such event, the piezo-motor stops traveling to its target location and instead travels to the next target location.

During our testing, the switch never got fully stuck and always successfully resumed operation after an positioning error event. Those events occurred more frequently when traveling to port T₂. For this port, the mean absolute positioning error is still very low, μ(|Δ|)=1.97 μm but with an increased rate of positioning error events to 0.055%. The shape of the shape of the histogram suggests that the switch tends to overshoot slightly, possibly due to tighter assembly on this side of the switch. Although the switching performance is sufficient for example applications, the switch positioning accuracy may be improved if the switching speed is reduced.

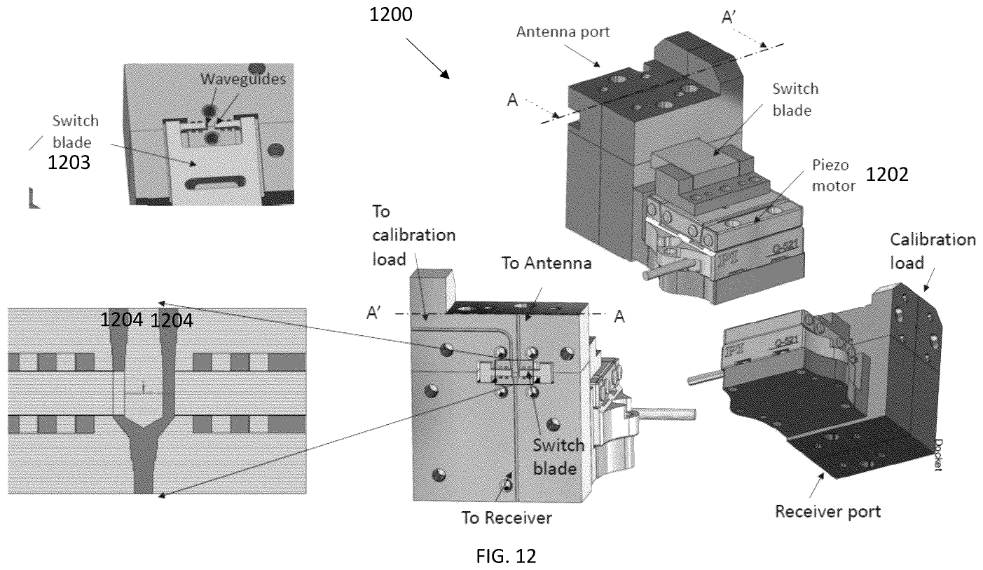

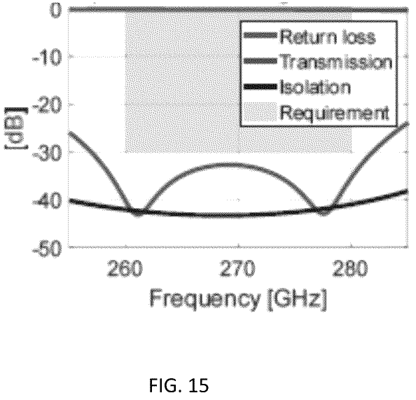

FIGS. 12-15 illustrate a low-loss terahertz switch 1200 comprising a Y-junction waveguide section where the terahertz receiver system is connected to the Y-input and the load and antenna are connected to the two Y-branches comprising waveguides 1204. The switch further comprises a metallic switch blade 1203 whose position is precisely controlled (with nanometer precision) by the piezo electric motor 1202 so as to open one waveguide 1204 branch (e.g., connected to the antenna) while simultaneously closing the other waveguide branch (connected to a waveguide load). FIG. 15 shows the switch 1200 is designed such that a minimal reflection (less than 30 dB) exists from the short-circuited branch back to the receiving system. The piezoelectric motor 1202 is the Q-521.140 miniature linear stage of reference [16] above.

### REFERENCES FOR FIRST EMBODIMENT

The following references are incorporated by reference herein.
[1] R. H. Dicke, “The measurement of thermal radiation at microwave frequencies,” in Classics in Radio Astronomy. Springer, 1946, pp. 106-113.
[2] J. Sobolewski and Y. Yashchyshyn, “State of the art sub-terahertz switching solutions,” IEEE Access, vol. 10, pp. 12 983-12 999, 2022.
[3] M. Uzunkol and G. M. Rebeiz, “140-220 GHz SPST and SPDT switches in 45 nm CMOS SOI,” IEEE Microw. Wirel. Compon. Lett., vol. 22, no. 8, pp. 412-414, 2012.
[4] F. Meng, K. Ma, K. S. Yeo, and S. Xu, “Monolithic sub-terahertz SPDT switches with low insertion loss and enhanced isolation,” IEEE Trans. Terahertz Sci. Technol., vol. 8, no. 2, pp. 192-200, 2018.
[5] C. D. Cheon, M.-K. Cho, S. G. Rao, A. S. Cardoso, J. D. Connor, and J. D. Cressler, “A new wideband, low insertion loss, high linearity SiGe RF switch,” IEEE Microw. Wirel. Compon. Lett., vol. 30, no. 10, pp. 985-988, 2020.
[6] S. Tolunay Wipf, A. Go\ddot{ }ritz, M. Wietstruck, C. Wipf, B. Tillack, and M. Kaynak, “D-band RF-MEMS SPDT switch in a 0.13 μm SiGe BiCMOS technology,” IEEE Microw. Wirel. Compon. Lett., vol. 26, no. 12, pp. 1002-1004, 2016.
[7] “W-band reflective SPDT PIN diode switch.” [Online]. Available: https://www.eravant.com/75-to-110-ghz-30-db-isolation-wr-10-waveguide-w-band-reflective-spdt-pin-diode-switch{}[Accessed:27-May-2022]
[8] T. Reck, C. Jung-Kubiak, and G. Chattopadhyay, “A 700-GHz MEMS waveguide switch,” IEEE Trans. Terahertz Sci. Technol., vol. 6, no. 4, pp. 641-643, 2016.
[9] U. Shah, T. Reck, H. Frid, C. Jung-Kubiak, G. Chattopadhyay, I. Mehdi, and J. Oberhammer, “A 500-750 GHz RF MEMS waveguide switch,” IEEE Trans. Terahertz Sci. Technol., vol. 7, no. 3, pp. 326-334, 2017.
[10] S. Rahiminejad, S. Van Berkel, R. H. Lin, C. Jung-Kubiak, G. Chat-topadhyay, and M. Rais-Zadeh, “A MEMS contactless rotating terahertz waveguide switch,” in 2022 IEEE 35th International Conference on Micro Electro Mechanical Systems Conference (MEMS), 2022, pp. 223-226.
[11] P.-S. Kildal, “Definition of artificially soft and hard surfaces for electromagnetic waves,” Electronics Letters, vol. 24, no. 3, pp. 168-170, 1988.
[12] D. Sievenpiper, L. Zhang, R. Broas, N. Alexopolous, and E. Yablonovitch, “High-impedance electromagnetic surfaces with a forbidden frequency band,” IEEE Trans. Microw. Theory. Tech., vol. 47, no. 11, pp. 2059-2074, 1999.
[13] P.-S. Kildal, E. Alfonso, A. Valero-Nogueira, and E. Rajo-Iglesias, “Local metamaterial-based waveguides in gaps between parallel metal plates,” IEEE Antennas Wirel. Propag. Lett., vol. 8, pp. 84-87, 2009.
[14] S. Rahiminejad, P. Enoksson, and S. Haasl, “Contactless waveguide switch and method for manufacturing a waveguide switch,” Dec. 3 2020, U.S. patent application Ser. No. 16/762,332.
[15] E. Rajo-Iglesias and P.-S. Kildal, “Numerical studies of bandwidth of parallel-plate cut-off realised by a bed of nails, corrugations and mushroom-type electromagnetic bandgap for use in gap waveguides,” IET microwaves, antennas & propagation, vol. 5, no. 3, pp. 282-289, 2011.
[16] “Piezoelectric motor model/product number Q-521.140 by physic instrumente.” [Online]. Available at https://www.physikinstrumente.com/en/products/linear-stages/miniature-linear-stages/q-521-q-motion-miniature-linear-stage-103151/, including but not limited to all downloads, specifications, and user manuals.

### Second Embodiment: Rotary Switch

a. Contactless Waveguide Switch Structure

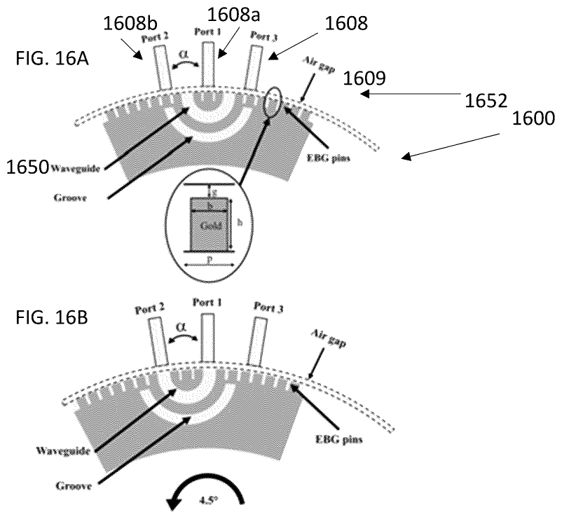

FIG. 16 illustrates an example switch comprising a U-bend waveguide 1650 placed in a rotating disc. On the periphery of the disc there are three waveguide ports, Port 1, Port 2 and Port 3, as shown in FIG. 16a. When the disc rotates around its axis, the U-bend waveguide connects the main waveguide port to one of the two waveguide 1608 ports at a time (the U-bend will connect two of the ports, either Port 1 and 2 or Port 1 and 3). To allow movement of the disc without stiction, there is an airgap (e.g., 10 microns) between the U-bend waveguide and its connecting ports.

To isolate the main waveguide port (Port 1) from the “closed” waveguide port without mechanical contact, a metamaterial (EBG) surface in the shape of corrugations surrounds the U-bend waveguide and a metallic surface is placed opposite the corrugations. The metallic surface is placed less than λ/4 from the U-bend waveguide to create a stop-band, thus confining the electromagnetic wave to propagate from the waveguide ports to the U-bend waveguide 1650 without any contact between the ports and the U-bend waveguide. Thus, the EBG surface is placed on each side of the ports of the U-bend so as to prohibit the incoming and outgoing electromagnetic wave from propagating to the sides even though there is an air gap present [31].

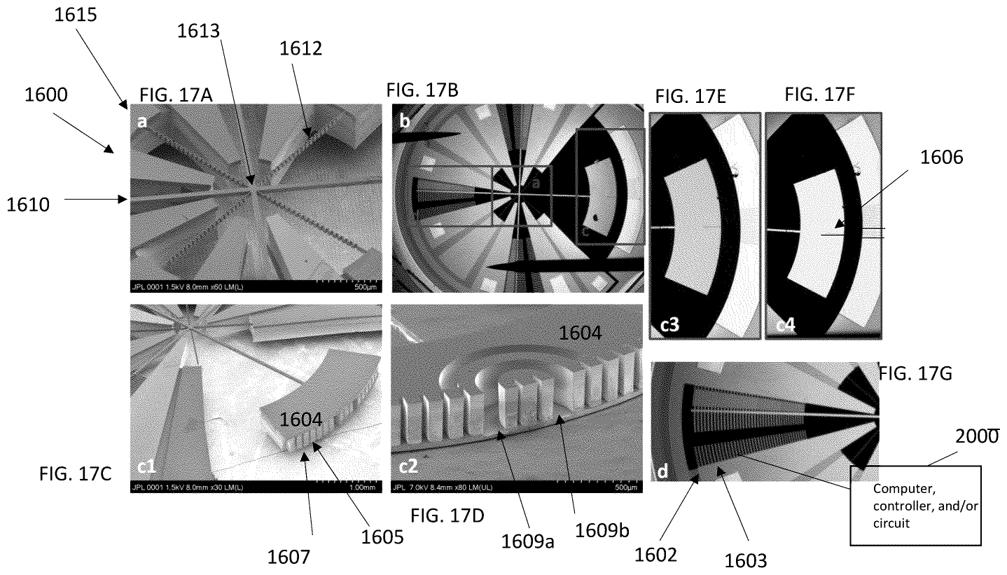

The EBG is inspired by gap waveguide technology, which uses an AMC surface in close proximity (<λ/4) to a PEC surface to create a stopband. The boundary conditions of both surfaces prevents the existence of the electromagnetic field in between these surfaces. Due to fabrication limitations, we here use a 1-dimensional array of EBG pins instead of a 2-dimensional array of EBG pins commonly used in gap waveguide technology. The EBG consist of rows of pins on both sides of the U-bend as well as between the two ports of the U-bend to avoid crosstalk. In this example, the ports are separated by 9°; and separation at a radius of r=4.25 mm allows three pins or 2 corrugations between the ports, which is sufficient to create a stopband at 10 micrometer air gap. A unit cell of the EBG pin with height h, width b period p and gap g can be seen in FIG. 17a. The depth of the pin is the same as the U-bend groove, 380 micrometers.

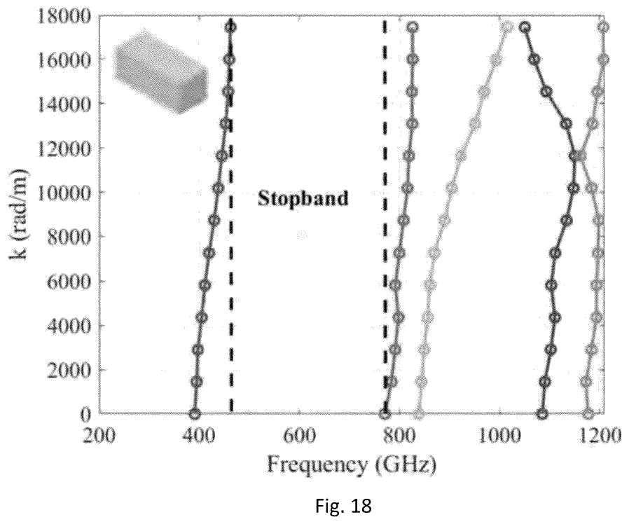

FIG. 18 show the simulated dispersion plot for a simplified version of the unit cell in order to determine the stopband. The unit cell was simulated using HFSS, where the top, front and back boundaries are PEC surfaces. The simulated dispersion plot shows a stop band between 460 and 770 GHz for the parameters shown in Table II. Since the disc is micromachined in silicon, the EBG pins are long (the same depth as the U-bend waveguide) as opposed to the squared pins in gap waveguides, a.k.a. bed of nails [32], [33].

TABLE II

| parameters for the unit cell shown in FIG. 16a used to simulate | |
|---|---|
| the response in FIG. 18 | |
| Unit cell parameter | dimensions |
| height (h) | 150 μm |
| gap (g) | 10 μm |
| width (b) | 130 μm |
| period (p) | 180 μm |

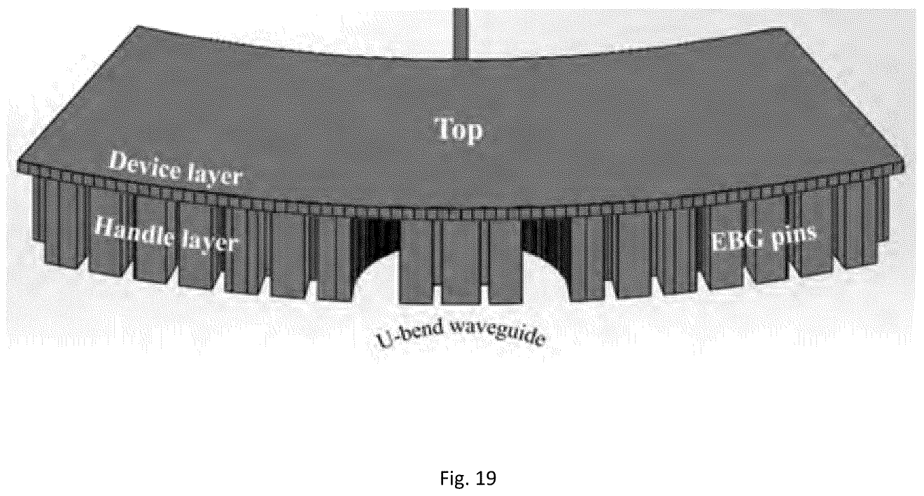

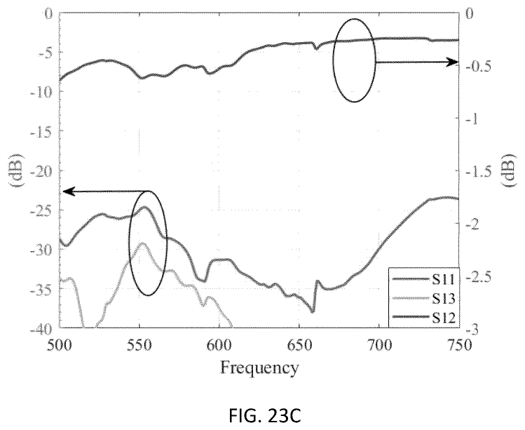

Since the EBG surface is only a 1-dimensional array instead of a 2-dimensional array, leakage can occur both below and on top of the waveguide disc, 3. To address this issue, the disc can be fabricated using a Silicon on Insulator (SOI) wafer. The U-bend waveguide and the pins can be made in the handle layer. Ontop of the EBG surface the device layer extends all the way to the edge of the pins to avoid leakage on the top side of the disc, FIG. 19. For the waveguide disc to be able to move a separation between it and the block is needed. To reduce leakage below the disc, the separation is designed to be 2 microns and a λ/4 groove is placed outside the U-bend, FIG. 16. FIG. 23C shows the simulated S-parameters for this design,

b. Rotating MEMS Actuator

The disc rotates by actuating a rotating comb-drive to switch between positions P1 and P2 (FIG. 17B). The radius of the switch and comb-drive component is 4.25 mm (FIG. 17A). The rotating MEMS motor consists of four arms with a radius of R=4.25 mm as illustrated in FIG. 17A, so that the radius of the switch and the comb drive component is R=4.25 mm. The springs consist of four serpentine arms, all connected to the anchor placed at the center of rotation [34]. The springs together with the long axis for the fingers were designed to rotate 4.5° in response to an applied voltage of 90 V. The rotating comb-drive was simulated using COMSOL Multiphysics [35].

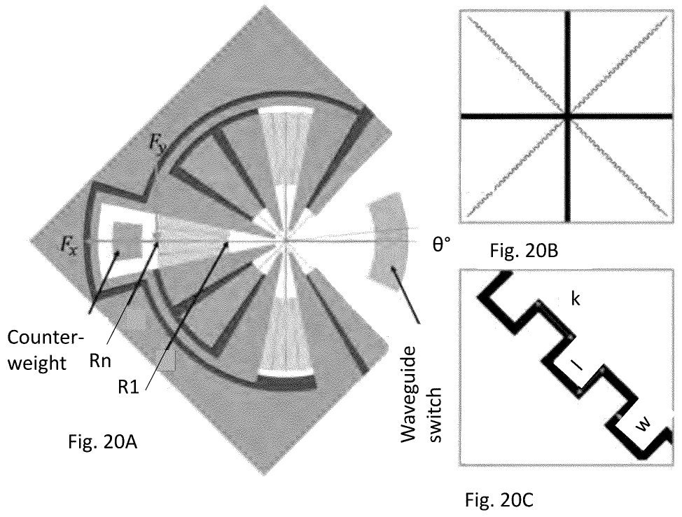

However, compared to the motor in [34], only three of the arms have a set of two-sided comb-drive actuators, while the fourth arm has the U-bend disc at its edge instead (FIG. 20). The comb-drive fingers are curved along the radial axis in order to allow rotational movement. The spring consist of four serpentine arms separated by 90°. The cross design of the spring (FIG. 20b) allows for a soft spring in the θ direction while still restricting the movement in the in-plane direction to increase the stability of the motor.

Although the total movement of the disc needs to be 9° for this port configuration example, the neutral position of the switch is chosen to be in between the ports so that the motor only needs to rotate 4.5° in each direction. This reduces the force needed to rotate to each position, which in turn reduces the voltage required. This is important since for space applications it is highly desirable to keep the voltage below 100 V to avoid static discharge in vacuum.

Since this is a rotating system, not only the applied force, but also the torque needs to be considered. The torque M needed to rotate an angle θ, depends on the distance Rn from the center and the force applied in the y-direction at the edge of the arm Fy.

$$M = {F}_{y} \times {R}_{n} \qquad ( 1 )$$

Each finger can apply a force F_{f} where ϵ is the permittivity, t is the finger thickness, V is the applied voltage and d is the

$${F}_{f} = \frac{ϵ {tV}^{2}}{d} \qquad ( 2 )$$

The total sum of all the distances R_{eff} for all fingers can be expressed by

$${R}_{eff} = {\sum }_{i = 1}^{n} {R}_{i} = {R}_{1} + ( n - 1 ) 2 ( d + {w}_{fi} ) \qquad ( 3 )$$

where R₁ is the radial distance to the finger closest to the center, n is the number of fingers and w_{fi} is the width of the finger with index i. The width of the fingers are gradually increasing the further out from the center they are placed. The longer fingers are made wider to maintain a high finger stiffness and avoid pull-in when voltage is applied.

The total torque applied on one arm is determined by the force at each finger (Eq. 2) and the sum of the distances (Eq. 3)

$${M}_{A} = {F}_{f} {R}_{eff} \qquad ( 4 )$$

Using Eq. 1 and Eq. 4, a relationship between the applied voltage and the force in the y-direction at a distance Rₙ can be shown

$${F}_{y} = 3 \times \frac{ϵ {tR}_{eff} {V}^{2}}{{R}_{n} d} \qquad ( 5 )$$

The MEMS motor has three arms and therefore, the torque will be three times larger.

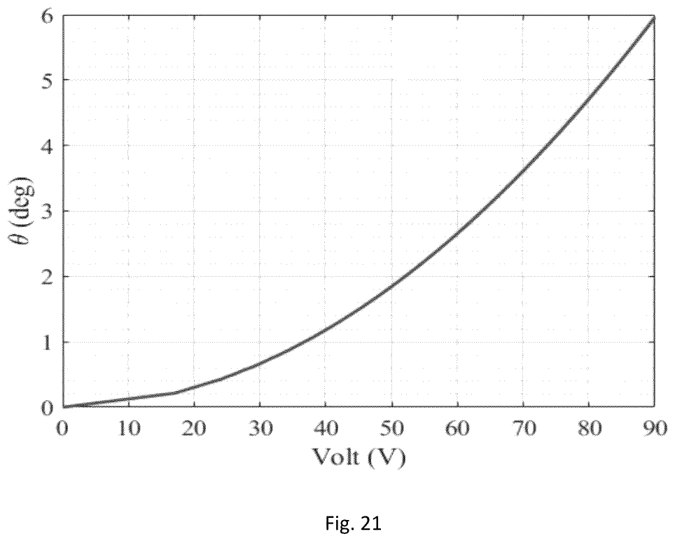

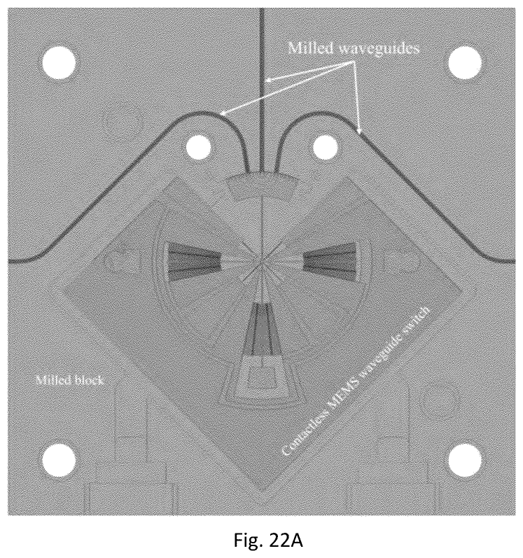

FIG. 21 shows the required voltage to rotate θ degrees. The plot is based on simulations using COMSOL multiphysics [35] of an applied force in the y-direction at the edge of the arm (FIG. 20) using Eq. 5.

The cross-spring performance (FIG. 20b and c) was also simulated using COMSOL Multiphysics [35], using a simplified design with only two arms in the x-direction attached
constant kₑ [34] was determined similarly by applying a force (F_{y}) in the y direction at the edge of the arm (FIG. 20a). The spring system has two requirements, first it needs to be able to rotate 4.5° with a voltage below 100 V and second kᵣ>kₑ to avoid instability. kₑ is determined using Eq. 6 from [34].

$${k}_{e} \approx \frac{2 ϵ {tV}^{2}}{{d}^{3}} {\sum }_{i = 1}^{n} {R}_{i} {θ}_{i} \qquad ( 6 )$$

The dimensions of the spring design that was optimized to fulfill these requirements are presented in Table II.

TABLE II

| Spring parameters, w, & and l are marked in FIG. 20 b and c | |
|---|---|
| while m is the number of turns for each serpentine has. | |
| Parameter | dimension (μm) |
| w | 6 μm |
| k | 28 μm |
| l | 35 μm |
| m | 20 |

The thickness of the springs and arms are 50 μm, however the waveguide opening of the switch needs to be 380 μm. Therefore, the disc thickness is 50 μm+380 μm. This creates an imbalance in the z-direction. To address this a counter weight was added to the design (see FIG. 20a), and the area of the disc was reduced to make it lighter.

c. Simulations

FIG. 17C shows simulations of the waveguide section of the switch with ANSYS Electronics Desktop [38]. The simulated transmission, reflection and isolation of the switch are presented in FIG. 23. The simulations have 10 μm gap from the connecting waveguide to ports as well as 5 μm space underneath the waveguide disc to allow free rotational movement. The simulations only present data for the waveguide disc and do not include the length of the connecting waveguides (which depend on the system).

d. Block Design and Alterations

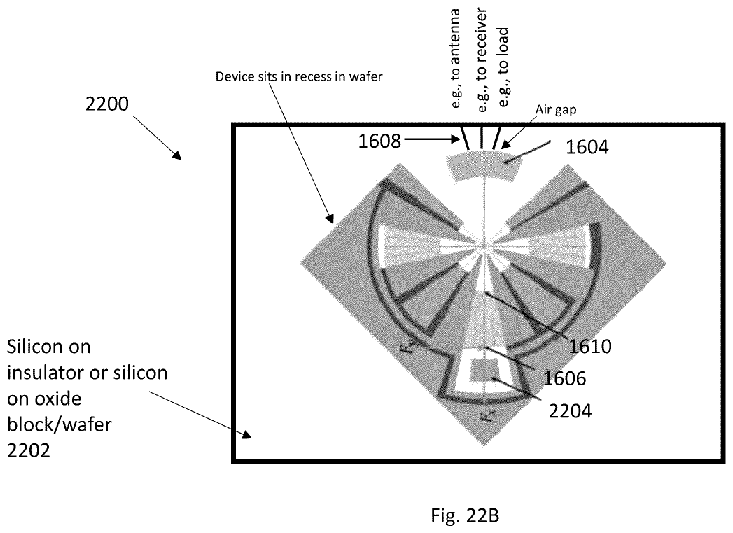

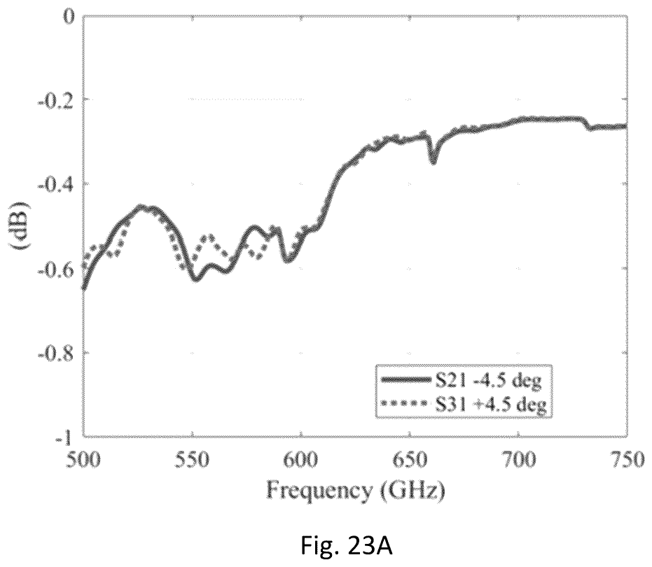

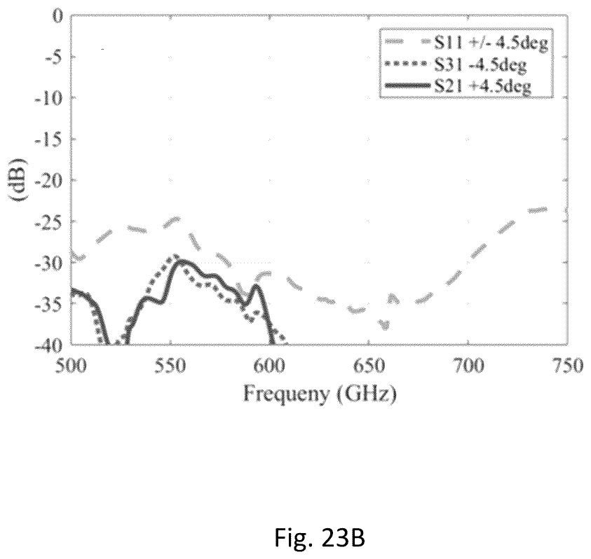

To measure the contactless MEMS waveguide switch, a gold plated brass block was designed, so that the MEMS waveguide switch could connect to standard WR 1.5 waveguide ports. Due to the size of the waveguide ports and its alignment pins the block had the outer dimensions of 24 mm×24 mm×10 mm. The large size of the block resulted in long waveguide paths connecting the MEMS switch to the ports (see FIG. 22). The short waveguide in FIG. 22 was 7.74 mm long and the two longer waveguides were 15.48 mm long each. The disc also requires a separation underneath it so that it can rotate freely inside the block.

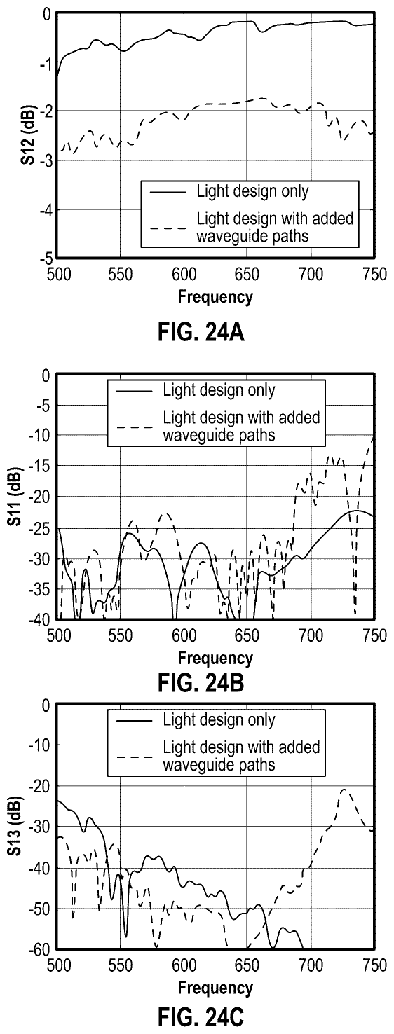

With the waveguide disc redesigned to be lighter, the added waveguide paths, their conduction losses from the block, and the separation needed underneath the waveguide disc, the electromagnetic performance was affected compared to the stand-alone design presented in II-a above. FIG. 24 shows the simulations of transmission (S₂₁), the reflection (S₁₁) and the isolation (S₃₁) for the lighter design with and without the block waveguide paths (15.48 mm+7.74 mm at a conduction of 3e7) for a 10 μm air gap and a 5 μm separation.

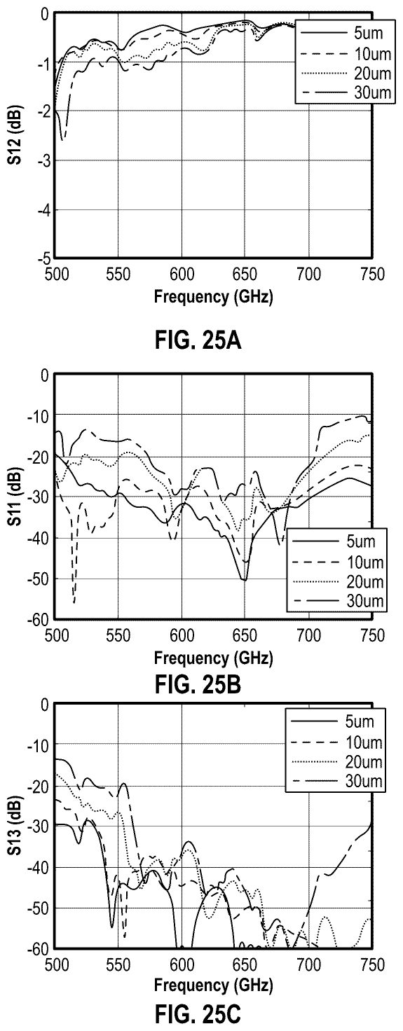

The performance of the waveguide switch is robust to variations in air gaps (FIG. 16) as shown in FIG. 25. There are no significant changes in S-parameter of the device with air gaps ranging from 5-30 μm.

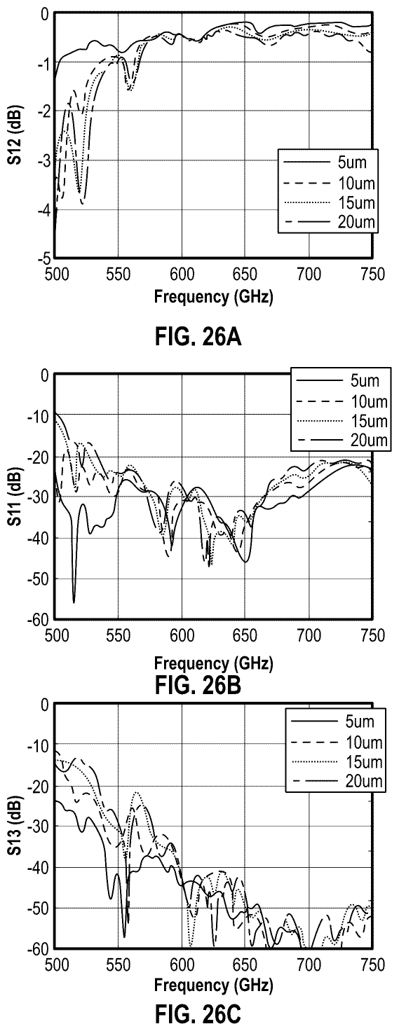

Simulations were also performed to see how much the separation between the disc and the block affected the performance. FIG. 26 shows the simulated S-parameters for different separations (5, 10, 15 μm and 20 μm) underneath the EBG surface.

e. Fabrication and Assembly

The comb-drive and springs were made to have a thinner thickness (e.g., 50 μm) to be able to rotate the switch as much as possible (e.g., ±4.5°) at a relatively low voltage (<100 V). The waveguide disc however, needed to be thicker (e.g., in this example 380 μm thick) to house the U-bend waveguide that matches the WR 1.5 ports (380 μm×190 μm). Therefore, an SOI wafer (in this example 50 μm/2 μm/390 μm or 50 μm device layer/2 82 m buffered oxide (BOX) layer/385 μm handle layer) was used to fabricate the contactless MEMS waveguide switch. The extra thickness in the handle layer was used to etch spacers underneath the chip to allow separation between the waveguide disc and the block so it can rotate freely inside the block.

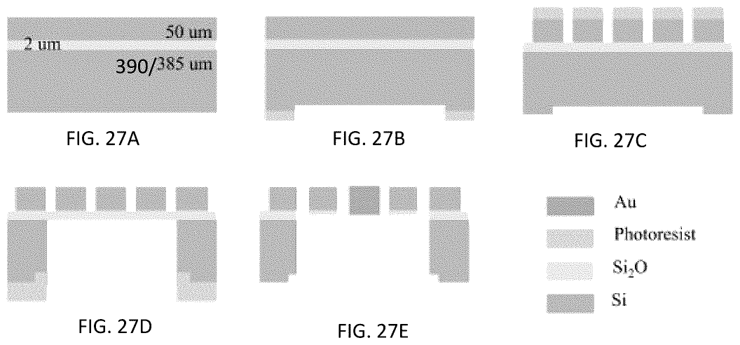

FIG. 27 shows the schematic process flow for fabricating the rotating MEMS waveguide switch. The back side of the wafer is patterned and etched 5 μm to define the spacers that allow for free rotation of the switch (FIG. 27B). The front side of the wafer is patterned and etched using a deep reactive ion etch (DRIE) process (FIG. 27C). The back side of the wafer is also patterned and etched using a silicon DRIE process (FIG. 27D). The BOX layer is removed from the back using dry etching and the key parts are sputtered with Ti/Au to make electrical contacts for the application of an actuation voltage (FIG. 27E).

The detailed fabrication steps are described as follows:

1. The backside (handle layer) of the wafer was patterned using UV photo-lithography and AZ5214 photoresist, defining the spacers. The spacers were then etched 10 μm deep using Deep Reactive Ion etching (DRIE), FIGS. 27a and 27b.

2. The front side (device layer) was patterned using the negative photoresist nLOF 2035 together with image reversal, in order to define the width of the springs (6 mm) as well as defining the comb-drive. A photoresist mask was used when the front side was etched with DRIE down to the buried oxide (BOX) layer, FIG. 27c.

3. The wafer was flipped once again and the backside was patterned with AZ9260 to define the waveguide and the groove in the waveguide disc, as well as to open up the area underneath the comb-drive and springs. The backside was etched with DRIE down to the BOX layer, FIG. 27d.

4. The BOX was removed by using fluorine based (CHF3;O2) inductive coupled plasma (ICP) etch from the backside; thus, releasing the springs and the comb-drive.

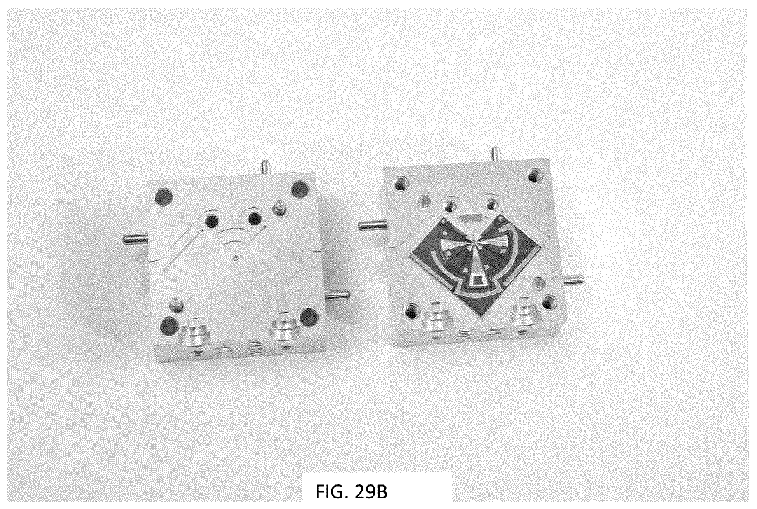

5. Silicon shadow masks were used during sputtering of Ti/Au on the front and back of the wafer. At the back of the wafer only the waveguide disc was sputtered with Ti/Au(30 nm/2 μm) for it to act as a waveguide from an electromagnetic point of view. At the front of the wafer, the gold pads and the top of the waveguide disc were sputtered with Ti/Au(30 mm/1 μm), FIG. 27e and FIG. 29.

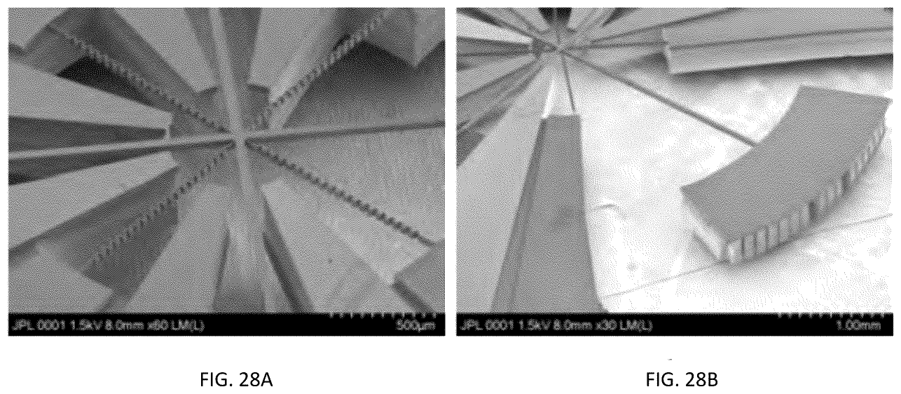

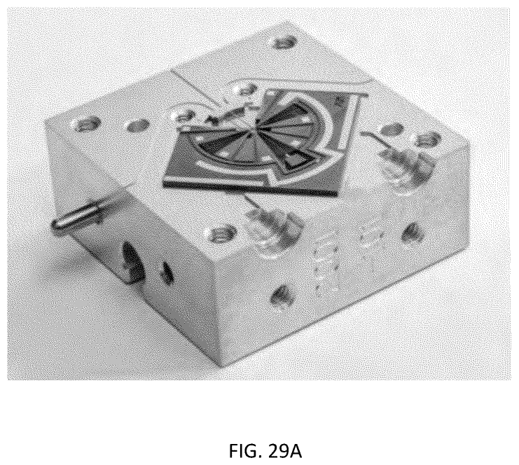

FIG. 28 shows Scanning electrode microscope (SEM) images of the springs and the waveguide disc of the fully fabricated MEMS waveguide switch.

To assemble the rotating contactless switch into the measurement block, the switch was first placed into the cavity of the bottom half of the block and was manually aligned under a microscope. Then it was held in place with cyanoacrylate glue. Jumper wires were then added to bridge the contact pads on the switch to each other, to the block for ground, and to the bias pins that goes to the external SMA connectors. These wires were attached using silver epoxy, which was then cured at 120° C. for one hour. After each gluing step, the switch was visually verified that it was still aligned and was able to freely rotate by pushing on it from both sides with a needle probe. Finally, before closing the block, the switch was tested with the block still open by applying a bias voltage to the SMA pins and verifying that the switch could be electrostatically actuated. FIG. 29 shows the fully fabricated contactless waveguide switch mounted inside the measurement block.

f. Characterization

The three arms of the MEMS switch are actuated at the same time allowing the moment to be three times larger compared to that for one arm (for the same voltage). The actuation voltage needed was determined by applying an increasing voltage with probes until the line marker (FIG. 17D and 17E) matches the opposing Vernier lines at 4.5° for both directions.

### Submillimeter Wave Characterization

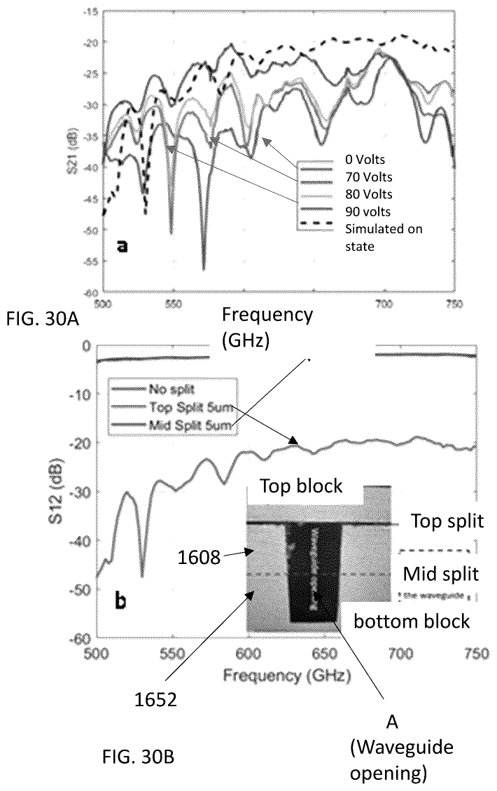

The MEMS switch was placed inside the measurement block with the three connecting waveguide ports milled into it. The block was connected to a network analyzer (PNA-X) with two VDI extenders for characterization. The applied voltage to the MEMS switch was increased from 70 V to 90 V, with 90 V placing the MEMS switch in its fully actuated state, and the transmission was measured. FIG. 30A shows the increase of transmission with the applied voltage, although in its fully actuated state, S21 <−20 dB. The modelled S21 value for the switch, including the waveguide losses, was around −3 dB. FIG. 30B shows the reason for the added loss is the larger than expected split between the two block parts placed at the edge of the waveguide (providing an additional 5 micrometer gap). Simulations show that this gap, together with transmission to around −20 dB (FIG. 30B), agrees with the measurement results. Example waveguide blocks defining a waveguide 1608 using a top block and a bottom block include those described in [39], [41] or in the following section. For the data in FIG. 30, the split in the measuring waveguide block used to measure the MEMS device is placed at the top of the waveguide opening (not in the middle).

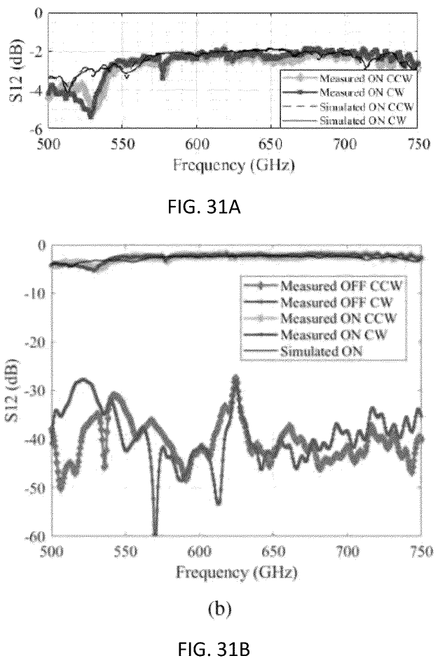

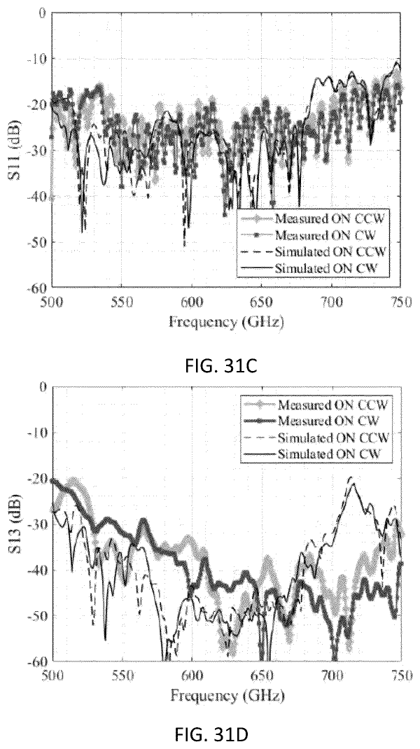

FIG. 31 shows additional measurements of the S-parameter measurements of the fabricated MEMS switch together with an optimized milled block (split in the waveguide block in the middle of the waveguide opening) performed using an Agilent PNAX system with VDI WR-1.5 VNA extenders. A standard SOLT calibration was performed using Virginia Diodes Inc's calibration kit. FIG. 31 shows the measured Sparameters of the MEMS switch in its ON and OFF states for both directions, Clockwise (CW) and counter-clockwise (CCW). The data shows improvement in the measured values of the S parameters (as compared to the measurements in FIG. 30) increased accuracy in the measurement as evidenced by better agreement with the simulations—due to the split in the waveguide block being placed in the middle of the waveguide opening rather than the top, as well as improvements to the design, such as using the counter weight and a lighter disc etc. FIG. 31b shows the measured S₂₁ of the switch in its neutral position (OFF) and when it is fully actuated (ON) for both directions, CW and CCW. FIG. 31a shows a close up of the S₂₁ in the ON state. S₂₁ is 2.5 dB between 550-750 GHz and higher at frequencies below 550 GHz. The transmission losses are higher when comparing to the simulations of only the waveguide disc (FIG. 18). However, when adding the long waveguide paths of the measurement block, a 10 micron air gap and 10 micron separation underneath the disc (Black lines in FIG. 31), the measurements agree well with simulations. The increased separation underneath the disc was needed to avoid the disc getting stuck on unwanted bumps of the milled block

FIG. 31c shows the measured reflection (S₁₁) when the MEMS switch is fully actuated (ON) for both directions CW and CCW, together with the simulated S₁₁ with the full waveguide paths, a 10 μm air gap and a 10 μm separation underneath the disc. The reflection was below −20 dB between 550-700 GHz and slightly higher in the rest of the band. The higher losses below 550 GHz and above 700 GHz is probably due to misalignment between the WR 1.5 ports and the block, as well as misalignment of the switch inside the block. The 10 μspace underneath the disc, places the waveguide disc higher than intended and the waveguides of the switch are not aligned with the waveguides of the block, thus increasing the reflections of the system.

FIG. 31d shows the measured isolation (S₁₃) together with simulations between Port 1 and 3, when Port 1 and 2 are connected and vice versa (FIG. 16), for both directions CW and CCW. The measured S₁₃ is below −20 dB through the band and below −30 dB between 550-750 GHz. The small discrepancy between the CW measurements and the CCW measurements are believed to be due to the irregularities in the measurement block. For simulations in 14 the light waveguide design discussed in section II-A was considered together with a 10 μm separation underneath the block.

The main contributor to the losses are the long waveguide paths in the milled block and their conduction losses as seen in FIG. 24 which compares the performance with and without the waveguides. It can also be seen in FIGS. 25 and 26 that both a change in air gap as well as separation (i.e. the alignment of the MEMS waveguide switch inside the block) can affect the reflection and isolation. It can also be seen that this misalignment affects the lower band (<550 GHz) more than rest of the band.

The uncertainty of the assembly and the block tolerances can provide a number of different combinations of misalignments that could affect the measurements, the simulation in FIG. 31 is only one example. It can be advantageous to place the MEMS switch inside a microfabricated silicon system, where alignment can be better controlled and waveguide paths can be reduced.

### Electromechanical Characterization

FIG. 17 presents microscopic images of the MEMS waveguide switch when it was actuated completely and rotated 4.5° as marked by the vernier lines (FIG. 17F). FIG. 17E shows the disc in its neutral state and FIG. 17F shows the actuated state.

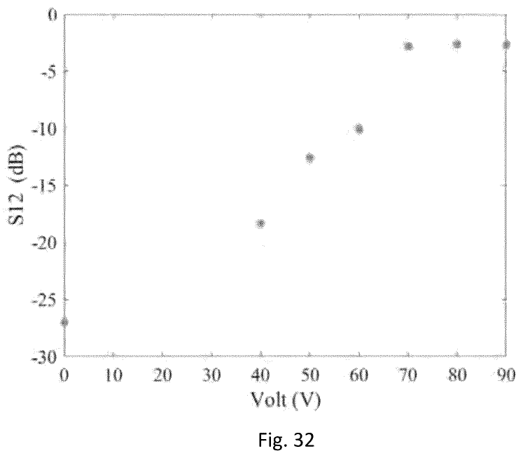

As seen in FIG. 21, the rotating contactless MEMS waveguide switch with counterweight was designed to rotate 4.5° at 78 V. FIG. 32 shows the transmission response (S₁₂) at the center of the band (635 GHz) for different voltages. The device reached its maximum transmission at 70 V, i.e. when it was fully actuated. The lower measured actuation voltage as compared to design value was due to the spring width being slightly narrower than the intended value of 6 μm.

The MEMS waveguide switch was also subjected to a lifetime measurement, where the switch was connected to a power sensor in one end and a 528 GHz RF chain and W band synthesizer in the other end. The switch was alternated between the CW state and the CCW state by a python controlled Bias control, which alternated the applied voltage for both sides between 90 V and 0 V at a frequency of 0.5 Hz.

The switch can get stuck due to debris inside the block underneath the disc. Lifetime measurements concluded that the device was actuated a total of roughly 430 K cycles before the measurement was aborted due to stiction. After 430K cycles the switch was still operational.

### REFERENCES FOR SECOND EMBODIMENT

The following references are incorporated by reference herein.
[1] P. H. Siegel, “Terahertz technology,” pp. 910-928, mar 2002.
[2] K. B. Cooper and G. Chattopadhyay, “Submillimeter-wave radar,” in IEEE Microwave Magazine, vol. 15, no. 7. Institute of Electrical and Electronics Engineers Inc., nov 2014, pp. 51-67.
[3] G. Chattopadhyay, A. Tang, S. Khanal, J. W. Kooi, J. V. Siles, D. Hayton, C. Jung-Kubiak, S. L. van Berkel, A. Maestrini, C. Lee, and I. Mehdi, “Highly-Compact Terahertz Spectrometers on Ultra-Small Platforms,” in Proc. 32nd International Symposium on Space Terahertz Technology (ISSTT), Baeza, 2022
[4] S. Gulkis, M. Frerking, J. Crovisier, G. Beaudin, P. Hartogh, P. Encrenaz, T. Koch, C. Kahn, Y. Salinas, R. Nowicki, R. Irigoyen, M. Janssen, P. Stek, M. Hofstadter, M. Allen, C. Backus, L. Kamp, C. Jarchow, E. Steinmetz, A. Deschamps, J. Krieg, M. Gheudin, D. BockeléeMorvan, N. Biver, T. Encrenaz, D. Despois, W. Ip, E. Lellouch, I. Mann, D. Muhleman, H. Rauer, P. Schloerb, and T. Spilker, “MIRO: Microwave instrument for Rosetta orbiter,” Space Science Reviews, vol. 128, no. 1-4, pp. 561-597, may 2007.
[5] Further information on one or more embodiments of the invention can be found in S. Rahiminejad, S. Van Berkel, R. H. Lin, C. Jung-Kubiak, G. Chattopadhyay, and M. Rais-Zadeh, “A Mems Contactless Rotating Terahertz Waveguide Switch,” Proceedings of the 35^{th} IEEE International Conference on Micro Electro Mechanical Systems (MEMS), vol. 2022-Janua, pp 223-226, 2022. DOI: 10.1109/MEMS51670.2022.9699786
[6] L. Larson, R. Hackett, M. Melendes, and R. Lohr, “Micromachined microwave actuator (MIMAC) technology-a new tuning approach for microwave integrated circuits,” IEEE 1991 Microwave and MillimeterWave Monolithic Circuits Symposium. Digest of Papers, 1991.
[7] M. Daneshmand and R. R. Mansour, “Multiport MEMS-based waveguide and coaxial switches,” in IEEE Transactions on Microwave Theory and Techniques, vol. 53, no. 11, nov 2005, pp. 3531-3537.
[8] H.-C. Lee, J.-Y. Park, and J.-U. Bu, “Piezoelectrically actuated RF MEMS DC contact switches with low voltage operation,” IEEE Microwave and Wireless Components Letters, vol. 15, no. 4, 2005
[9] M. Tang, A. Q. Liu, and A. Agarwal, “A low-loss single-pole-doublethrow (SPDT) switch circuit,” in TRANSDUCERS and EUROSENSORS '07—4th International Conference on Solid-State Sensors, Actuators and Microsystems, 2007, pp. 675-678.
[10] H. Zareie and G. M. Rebeiz, “Compact high-power SPST and SP4T RF mems metal-contact switches,” IEEE Transactions on Microwave Theory and Techniques, vol. 62, no. 2, pp. 297-305, 2014.
[11] A. Kashani Ilkhechi, H. Mirzajani, E. Najafi Aghdam, and H. Badri Ghavifekr, “A new electrostatically actuated rotary three-state DCcontact RF MEMS switch for antenna switch applications,” Microsystem Technologies, vol. 23, no. 1, pp. 231-243, jan 2017.
[12] G. M. Rebeiz and J. B. Muldavin, “RF MEMS switches and switch circuits,” IEEE Microwave Magazine, vol. 2, no. 4, pp. 59-71, dec 2001.
[13] T. Seki, Y. Uno, K. Narise, T. Masuda, K. Inoue, S. Sato, F. Sato, K. Imanaka, and S. Sugiyama, “Development of a large-force low-loss metal-contact RF MEMS switch,” Sensors and Actuators, A: Physical, vol. 132, no. 2, pp. 683-688, nov 2006.
[14] Y. Uno, K. Narise, T. Masuda, K. Inoue, Y. Adachi, K. Hosoya, T. Seki, and F. Sato, “Development of SPDT-structured RF MEMS switch,” in TRANSDUCERS 2009—15th International Conference on Solid-State Sensors, Actuators and Microsystems, 2009, pp. 541-544.
[15] M. Daneshmand, R. R. Mansour, and N. Sarkar, “RF MEMS waveguide switch,” in 2004 IEEE MTT-S International Microwave Symposium Digest (IEEE Cat. No.04CH37535), vol. 2. IEEE, 2004, pp. 589-592
[16] Z. Baghchehsaraei, U. Shah, J. Aberg, G. Stemme, and J. Oberhammer, “MEMS reconfigurable millimeter-wave surface for V-band rectangularwaveguide switch,” in International Journal of Microwave and Wireless Technologies, vol. 5, no. 3. Cambridge University Press, jun 2013, pp. 341-349.
[17] N. Vahabisani and M. Daneshmand, “Monolithic Millimeter-Wave MEMS Waveguide Switch,” IEEE Transactions on Microwave Theory and Techniques, vol. 63, no. 2, pp. 340-351, feb 2015.
[18] U. Shah, T. Reck, E. Decrossas, C. Jung-Kubiak, H. Frid, G. Chattopadhyay, I. Mehdi, and J. Oberhammer, “500-750 GHz submillimeter-wave MEMS waveguide switch,” in 2016 IEEE MTT-S International Microwave Symposium (IMS). IEEE, may 2016, pp. 1-4.
[19] T. Reck, C. Jung-Kubiak, and G. Chattopadhyay, “A 700-GHz MEMS Waveguide Switch,” IEEE Transactions on Terahertz Science and Technology, vol. 6, no. 4, pp. 641-643, 2016.
[20] T. Reck, C. Jung-Kubiak, and G. Chattopadhyay, “A 460 GHz MEMS-Based Single-Pole Double-Throw Waveguide Switch,” in 2018 IEEE/MTT-S International Microwave Symposium—IMS. IEEE, jun 2018, pp. 773-775.
[21] T. Amin, M. Huda, Y. Ning, G. Mckinnon, and J. Tulip, “A virtual pivot point MEMS rotary comb actuator for tunable laser applications,” in Proceedings of SPIE—The International Society for Optical Engineering, A. Forbes and T. E. Lizotte, Eds., vol. 8490 International Society for Optics and Photonics, oct 2012, p. 84900D.
[22] J. Brière, P.-O. Beaulieu, M. Saidani, F. Nabki, and M. Menard, “Rotational MEMS mirror with latching arm for silicon photonics,” in MOEMS and Miniaturized Systems XIV, W. Piyawattanametha and Y.-H. Park, Eds., vol. 9375. International Society for Optics and Photonics, feb 2015, p. 937507.
[23] J. Briere, M. Y. Elsayed, M. Saidani, M. Bérard, P. O. Beaulieu, H. Rabbani-Haghighi, F. Nabki, and M. Ménard, “Rotating circular micro-platform with integrated waveguides and latching arm for reconfigurable integrated optics,” Micromachines, vol. 8, no. 12, p. 354, dec 2017.
[24] E. Yablonovitch, “Inhibited Spontaneous Emission in Solid-State Physics and Electronics,” Physical Review Letters, vol. 58, no. 20, pp. 2059-2062, 1987.
[25] P.-S. Kildal, “Definition of artificially soft and hard surfaces for electromagnetic waves,” Electronics Letters, vol. 24, no. 3, pp. 168-170,1988.
[26] R. J. King, D. V. Thiel, and K. S. Park, “The Synthesis of Surface Reactance Using an Artificial Dielectric,” IEEE Transactions on Antennas and Propagation, vol. 31, no. 3, pp. 471-476, 1983.
[27] D. Sievenpiper, L. Zhang, R. F. J. Broas, N. G. Alexopolous, and E. Yablonovitch, “High-impedance electromagnetic surfaces with a forbidden frequency band,” IEEE Transactions on Microwave Theory And Techniques, vol. 47, no. 11, pp. 2059-2074, 1999.
[28] P.-S. Kildal, “Three metamaterial-based gap waveguides between parallel metal plates for mm/submm waves,” in 3 rd European Conference on Antennas and Propagation (EuCAP 2009), vol. 8, no. March, Berlin, Germany, 2009, pp. 84-87.
[29] J. Tayebpour, B. Ahmadi, M. Fallahzadeh, O. Shekoofa, and A. Torabi, “A waveguide switch based on contactless gap waveguide technology,” IEEE Microwave and Wireless Components Letters, vol. 29, no. 12, pp. 771-774, dec 2019.
[30] S. Van Berkel, S. Rahiminejad, R. Lin, and G. Chattopadhyay, “A 250310 GHz Piezo-Motor Actuated SPDT Waveguide Switch With High Isolation,” IEEE Transactions on Terahertz Science and Technology, vol. 13, no. 2, pp. 158-166, mar 2023
[31] P.-S. Kildal, E. Alfonso, A. Valero-Nogueira, and E. Rajo-Iglesias “Local metamaterial-based waveguides in gaps between parallel metal plates,” IEEE Antennas and Wireless Propagation letters (AWPL), vol. 8, pp. 84-87, 2009.
[32] M. Silveirinha, C. Fernandes, and J. Costa, “Homogenization and applications of the Fakirs bed of nails substrate,” in MELECON 2006 2006 IEEE Mediterranean Electrotechnical Conference, 2006, pp. 241-243.
[33] P.-S. Kildal, A. U. Zaman, E. Rajo-Iglesias, E. Alfonso, and A. ValeroNogueira, “Design and experimental verification of ridge gap waveguide in bed of nails for parallel plate mode suppression,” IET Microwaves, Antennas and Propagation, vol. 5, no. 3, pp. 262-270, 2011.
[34] J. A. Yen, C. N. Chen, and Y. S. Lui, “Large rotation actuated by in-plane rotary comb-drives with serpentine spring suspension,” Journal of Micromechanics and Microengineering, vol. 15, no. 1, pp. 201-206, jan 2005.
[35] “COMSOL Multiphysics®,” Stockholm, Sweden. [Online]. Available: www.comsol.com
[36] US Patent Publication No. 20200381793
[37] Low loss microelectromechanical system (mems) phase shifter by Sofia Rahiminejad, Maria A. Del Pino, Cecile D. Jung-Kubiak, Theodore J. Reck, and Goutam Chattopadhyay, US. Patent Publication No. 20210013569.
[38] ANSYS® Electromagnetics Suite, Release 2019 R2, Help System, Electronics Desktop, ANSYS, Inc.
[39] S. Van Berkel, S. Rahiminejad, R. Lin, and G. Chattopadhyay, “A 250310 GHz Piezo-Motor Actuated SPDT Waveguide Switch With High Isolation,” IEEE Transactions on Terahertz Science and Technology, vol. 13, no. 2, pp. 158-166, mar 2023
[40] Further information on one or more embodiments of the invention can be found in 500-750 GHz Contactless Rotating MEMS Single-Pole Double-Throw Waveguide Switch, Journal of Microelectromechanical Systems PP(99):1-11 PP(99):1-11 DOI:10.1109/JMEM.2024.3418335 by Sofia Rahiminejad et. al.
[41] Low loss microelectromechanical system (mems) phase shifter by Sofia Rahiminejad, Maria A. Del Pino, Cecile D. Jung-Kubiak, Theodore J. Reck, and Goutam Chattopadhyay, US. Patent Publication No. 20210013569.

### Example Applications

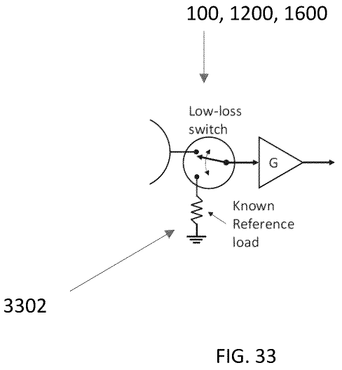

FIG. 33 illustrates an example wherein the switch is used to switch between a reference load 3302 (e.g., for calibration of a sub-millimeter instrument such as a receiver) and an antenna.

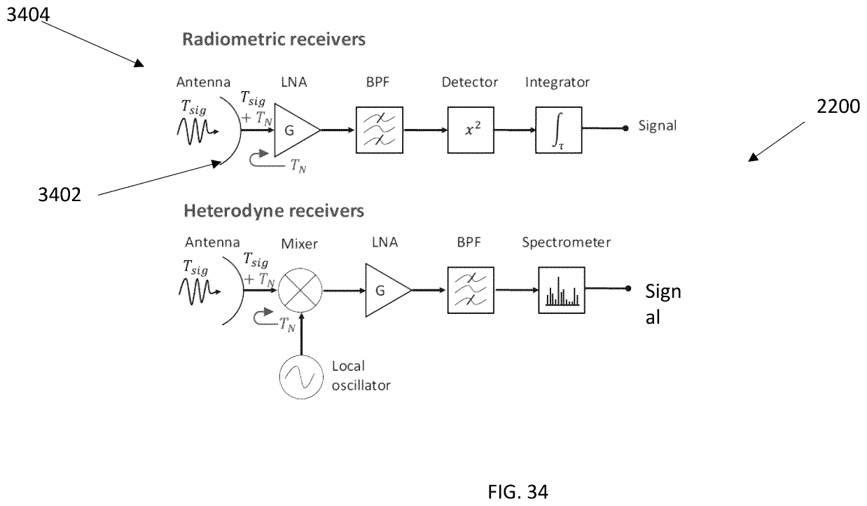

FIG. 34 illustrates example system 3404 receivers comprising a switch 1600 according to embodiments described herein, wherein the switch is positioned between the amplifier G or mixer and the antenna 3402 so as to switch between the antenna and a calibration load 3302. Embodiments of the present invention can be implemented in compact sub-millimeter wave instruments comprising the receiver with reduced power, volume, and mass. In some embodiments, the switch is implemented with the instrument on a CubeSat platform. Example instruments include a spectrometer system having application in molecular spectroscopy measurements for astronomy and earth sciences [1]. Molecular spectroscopy instruments can provide essential information for remote study of atmospheric composition and for measuring the surface properties of cold planetary and cometary bodies. Some of the advantages of operating at submillimeter-wave frequencies are the availability of wide-open bandwidths, high resolution possibilities, and high signal to noise ratio, due to the strong absorbance at these high frequencies, but at the cost of dealing with tight tolerances, and difficulty with integration [2]. Some submillimeter-wave spectrometers and radars are currently being developed to measure a variety of new science objectives, many of them are focused on detecting water. At 557 GHz, the water line is several orders of magnitude stronger than at lower frequencies, thus increasing the chances to detect water on cold bodies. Calibration of these systems rely mostly on large, bulky quasi-optical flip-mirrors to redirect the receiver path to a free-space absorber [3]. A low-loss single-pole double-throw (SPDT) THz MEMS switch could replace flip-mirror based calibration system and thus help developing highly integrated spectrometer/radar systems with substantially reduced mass and power.

### Process Steps

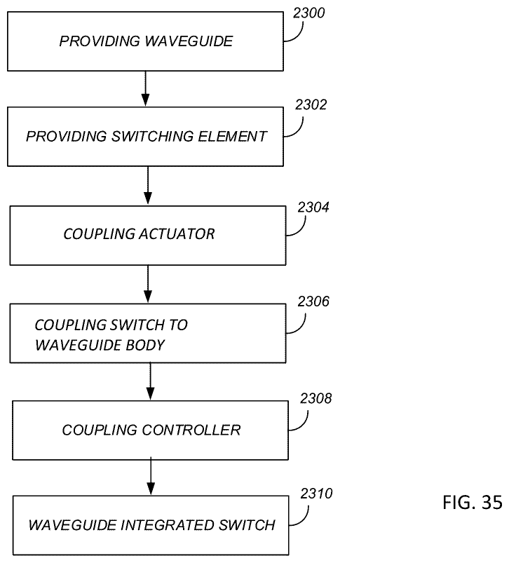

FIG. 35 illustrates a method of making a waveguide integrated switch.

Block 2300 represents providing or machining a waveguide body, block or member comprising one or more waveguides.

Block 2302 represents providing or fabricating a switching body or element or member.

Block 2304 represents coupling an actuator (or means for actuating or moving) to the switching body to form a switch.

Block 2306 represents optionally coupling the switch to the waveguide body, so that the actuator may actuate the switching body to open or close transmission of an electromagnetic wave to the one or more waveguides and the waveguide configured and dimensioned to guide the electromagnetic wave having a frequency in a range of 100 gigahertz (GHz) to 1000 terahertz (THz).

Block 2308 represents optionally coupling a controller, circuit, or computer to the waveguide integrated switch, for controlling the motor controlling the position of the switching body.

Block 2310 represents the end result, a switch, e.g., a waveguide integrated switch.

The switch can be embodied in many ways, including but not limited to, the following (referring also to FIGS. 16-35).

1. A switch, comprising:
an Micro-Electro-Mechanical System (MEMS) device comprising an actuator 1602, the actuator comprising a motor 1603 coupled to a switching body 1604 and wherein:
the switching body comprises a connector waveguide 1650 comprising a first connector port and a second connector port spaced by a length of the connector waveguide such that the first connector port couples to a first port (port 1) of a first waveguide 1608a and the second connector port couples to a second port (port 2) of a second waveguide 1608b through an air gap 1609 when the motor rotates the switching body, about a center of rotation, to an on position, and
the waveguides are configured and dimensioned to guide an electromagnetic wave having a frequency in a range of 100 gigahertz (GHz) to 1000 terahertz (THz).

2. The switch 1600 of clause 1, further comprising a waveguide block 1652 comprising the first waveguide and the second waveguide, wherein the actuator is inside the waveguide block.

3. The switch 2200 of clause 1 or 2, further comprising a silicon wafer 2202 comprising the first waveguide and the second waveguide integrated with the switch via the air gap.

4. The switch of any of the clauses 1-3, wherein the actuator comprises a rotary comb drive 1603.

5. The switch of any of the clauses 1-4, wherein the switching body further comprises an electromagnetic band gap (EBG) structure coupled to the connector waveguide.

6. The switch of any of the clauses 1-5, wherein:
the switching body comprises a metamaterial comprising an electromagnetic band gap structure for suppressing leakage of the electromagnetic wave sideways away from the transmission of the electromagnetic wave through the connector waveguide coupling the first waveguide to the second waveguide and when the switch is on, and
the metamaterial comprises a periodic structure having a dimension less than a wavelength of the electromagnetic radiation; e.g., comprising patterned metallization or a groove contouring a length of the connector waveguide, or a periodic structure comprising at least one of a corrugated surface or pins separated by air gaps in a sidewall of the switching body on either side of each of the first connector port and the second connector port.

7. The switch of any of the clauses 1-6, wherein the actuator comprises a plurality of comb drives and springs 1612 connected to an anchor 1613 such that moments applied to the anchor by the comb drives are balanced by the springs through spring deformation and the comb drives drive rotation of the switching body about the center of rotation at the anchor.

8. The switch 2200 of any of the clauses 1-7, wherein the actuator further comprises a counterweight 2204 connected to the switching body through the anchor to balance the switching body with respect to a balancing point at the anchor.

9. The switch of any of the clauses 1-8, wherein the switching body comprises an annular sector 1605 comprising a first sidewall 1607 comprising the first connector port 1609a and the second connector port 1609b, the first sidewall comprising a same radius of curvature as that of a second sidewall of a waveguide body 1652 comprising the first port and the second port around a periphery of the annular sector.

10. The switch of clause 8 or 9, further comprising the waveguide body around a periphery of the annular sector and separated by the air gap.

11. The switch of any of the clauses 1-10, wherein actuator further comprises arms 1610 connecting the switching body and the motor to the anchor, the arms comprising a single first arm and a plurality of second arms, and wherein:
the first single arm is connected at a first end to the switching body, at a second end to a counterweight 2202, and between the first end and the second end to the anchor; and each of the second arms connect a different one of the comb drives to the anchor.

12. The switch of clause 11, further comprising:
the comb drives 1603 equi-positioned about the center of rotation at the anchor, so as to synchronously drive the rotation of the annular sector about the anchor to couple or decouple the ports distributed along the second sidewall of the annular region; and
spring members 1612 each connected at one end to a mount 1615 or frame and at another end to the anchor so as to be symmetrically and equi-positioned about the rotational axis, each of the spring members equidistant between two adjacent ones of the second arms so that the number of second arms is equal to the number of spring members.

13. The switch of any of the clauses 7-12, wherein the spring members each comprise a serpentine arm or bendable beam.

14. The switch of any of the clauses 11-12 comprising multiple, e.g., 2, 3, or 4 of the arms and multiple, e.g., 2, 3, or 4 of the spring members wherein each of the spring members are connected to each other at the anchor and each of the arms are connected to each other at the anchor.

15. The switch of any of the clauses 11-14, comprising 4 of the arms and 4 of the spring members disposed in cross shaped structures so that each of the spring members are connected at right angles to each other at the anchor and each of the arms are connected at right angles to each other at the anchor.

16. The switch of any of the clauses 11-15, wherein a softness of a spring constant of the spring members 1612, a rigidity of the arms 1610 (comprising non spring beams), and a mass of the switching body are tuned to obtain a trade-off between increasing motional stability of the switching body and decreasing a magnitude of the voltages required to rotate the switching body between an on state and an off state decoupling the ports.

17. The switch of any of the clauses 11-16, wherein the spring constant of the spring members 1612, the rigidity of the arms 1610, and the mass of the switching body are such that the comb drive rotates the switching body by through an angle between a first position at which the switch couples two of the waveguides and the second position at which the switch is off or coupling another two of the waveguides, for the voltages having a magnitude less than 90 volts, and such that motional stability of the switching body enables reliable coupling of the electromagnetic wave between the first waveguide, the second waveguide, and the connector waveguide. In one or more embodiments, the angular distance through which the switching body moves depends on the length of the arm (e.g., longer arms, more fingers less voltage needed to drive the angular distance).

18. The device of any of the clauses 1-17, wherein the MEMS device comprises silicon or a semiconductor and the waveguides are patterned in silicon 2202 or a semiconductor piece integrated to the switch via the air gap

19. The device of any of the clauses 1-17, wherein the MEMS device comprises silicon or a semiconductor and the waveguides are patterned a metal block.

20. The device of any of the clauses 1-19, wherein the air gap is less than quarter of the wavelength of the electromagnetic radiation (e.g., to have some band gap, the smaller the air gap, the better isolation). Typically, the lower the frequency of the electromagnetic radiation, the bigger the air gap.

21. The device of any of the clauses 1-20, wherein the switching body has a clearance of at least 10 microns below the switching body. However, the clearance is scalable, as the frequency of the electromagnetic radiation is increased, the clearance decreases (e.g., doubling the frequency of the electromagnetic radiation allows half the clearance) to stop leakage of the electromagnetic radiation.

22. The device of any of the clauses 1-21, wherein the actuator sits in and/or is housed in recess in the waveguide block or waveguide body.

23. A method of making a MEMS switch, comprising:
obtaining a wafer comprising a buffered oxide layer between a handle layer and a device layer (e.g., FIG. 27A);
patterning a backside (handle layer) of the wafer to define the spacers (e.g., FIG. 27B);
patterning a front side (device layer) of the wafer to define a width of the spring members as well as defining the comb-drive, including etching regions down to the buried oxide (BOX) layer (e.g., FIG. 27C);.
patterning the backside to define a connector waveguide and a groove in the switching body and to open up an area underneath the comb-drive and springs, including etching regions of the backside to the BOX layer (e.g., FIG. 27D);
removing the BOX layer by etching from the backside; thus, releasing the springs and the comb-drive; and
sputtering metal on the front and back of the wafer, wherein metallization on the backside forms the connector waveguide (e.g., FIG. 27E).

24. The device of any of the clauses manufactured using the method of clause 23.

25. A method of operating the switch of any of the clauses 1-24, comprising applying a first voltage to the actuator to rotate the switching body to couple the waveguides and a second voltage to decouple the waveguides or couple another pair of waveguides.

26. A system 3404 comprising the switch of any of the clauses 1-25, wherein the waveguides 1608 comprise a first waveguide, a second waveguide, and a third waveguide, and further comprising a receiver connected to the first waveguide, an antenna 302 coupled to the second waveguide, and a load 3302 (e.g., reference load) coupled to the third waveguide, wherein the actuator switches between coupling the first waveguide and the second waveguide or coupling the first waveguide and the third waveguide.

### Conclusion

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A switch, comprising:
an Micro-Electro-Mechanical System (MEMS) device comprising an actuator, the actuator comprising a motor coupled to a switching body and wherein:
the switching body comprises a connector waveguide comprising a first connector port and a second connector port spaced by a length of the connector waveguide such that the first connector port couples to a first port of a first waveguide and the second connector port couples to a second port of a second waveguide through an air gap when the motor rotates the switching body, about a center of rotation, to an on position, and
the waveguides are configured and dimensioned to guide an electromagnetic wave having a frequency in a range of 100 gigahertz (GHz) to 1000 terahertz (THz).

2. The switch of claim 1, further comprising a waveguide block comprising the first waveguide and the second waveguide, wherein the actuator sits in a recess in the waveguide block.

3. The switch of claim 1, further comprising a silicon wafer comprising the first waveguide and the second waveguide integrated with the switch via the air gap.

4. The switch of claim 1, wherein the actuator comprises a rotary comb drive.

5. The switch of claim 1, wherein the switching body further comprises an electromagnetic band gap structure coupled to the connector waveguide.

6. The switch of claim 1, wherein:
the switching body comprises a metamaterial comprising an electromagnetic band gap structure for suppressing leakage of the electromagnetic wave sideways away from the transmission of the electromagnetic wave through the connector waveguide coupling the first waveguide to the second waveguide and when the switch is on, and the metamaterial comprises a periodic structure having a dimension less than a wavelength of the electromagnetic radiation.

7. The switch of claim 1, wherein the actuator comprises a plurality of comb drives and springs connected to an anchor such that moments applied to the anchor by the comb drives are balanced by the springs through spring deformation and the comb drives drive rotation of the switching body about the center of rotation at the anchor.

8. The switch of claim 7, wherein the actuator further comprises a counterweight connected to the switching body through the anchor to balance the switching body with respect to a balancing point at the anchor.

9. The switch of claim 7, wherein the switching body comprises an annular sector comprising a first sidewall comprising the first connector port and the second connector port, the first sidewall comprising a same radius of curvature as that of a second sidewall of a waveguide body comprising comprising the first port and the second port around a periphery of the annular sector.

10. The switch of claim 8, further comprising the waveguide body around a periphery of the annular sector and separated by the air gap.

11. The switch of claim 8, wherein actuator further comprises arms connecting the switching body and the motor to the anchor, the arms comprising a single first arm and a plurality of second arms, and wherein:
the first single arm is connected at a first end to the switching body, at a second end to a counterweight, and between the first end and the second end to the anchor; and
each of the second arms connect a different one of the comb drives to the anchor.

12. The switch of claim 11, further comprising:
the comb drives equi-positioned about the center of rotation at the anchor, so as to synchronously drive the rotation of the annular sector about the anchor to couple or decouple the ports distributed along the second sidewall of the annular region; and
spring members each connected at one end to a mount and at another end to the anchor so as to be symmetrically and equi-positioned about the rotational axis, each of the spring members equidistant between two adjacent ones of the second arms so that the number of second arms is equal to the number of spring members.

13. The switch of claim 12, wherein the spring members each comprise a serpentine arm or bendable beam.

14. The switch of claim 12 comprising 4 of the arms and 4 of the spring members disposed in cross shaped structures so that each of the spring members are connected at right angles to each other at the anchor and each of the arms are connected at right angles to each other at the anchor.

15. The switch of claim 12, wherein a softness of a spring constant of the spring members, a rigidity of the arms (comprising non spring beams), and a mass of the switching body are tuned to obtain a trade-off between increasing motional stability of the switching body and decreasing a magnitude of the voltages required to rotate the switching body between an on state and an off state decoupling the ports.

16. The switch of claim 12, wherein the spring constant of the spring members, the rigidity of the arms, and the mass of the switching body are such that the comb drive rotates the switching body by through an angle between a first position at which the switch couples two of the waveguides and the second position at which the switch is off or coupling another two of the waveguides, for the voltages having a magnitude less than 90 volts, and such that motional stability of the switching body enables reliable coupling of the electromagnetic wave between the first waveguide, the second waveguide, and the connector waveguide.

17. The device of claim 1, wherein the MEMS device comprises silicon or a semiconductor and the waveguides are patterned in silicon or a semiconductor piece integrated to the switch via the air gap

18. The device of claim 1, wherein the air gap is less than quarter of the wavelength of the electromagnetic radiation and the switching body has a clearance of at least 10 microns below the switching body.

19. A system comprising the switch of claim 1, wherein the waveguides comprise the first waveguide, the second waveguide, and a third waveguide, wherein the first waveguide is coupled to a receiver, the second waveguide is coupled to an antenna, and the third waveguide is coupled to a reference load, actuator is configured to rotates the switching body between a first position wherein the connector waveguide couples the first waveguide and the second waveguide and a second position wherein the connector waveguide couples the first waveguide to the third waveguide.

20. A method of making a MEMS switch, comprising:
obtaining a wafer comprising a buffered oxide layer between a handle layer and a device layer;
patterning a backside (handle layer) of the wafer to define the spacers;
patterning a front side (device layer) of the wafer to define a width of the spring members as well as defining the comb-drive, including etching regions down to the buried oxide (BOX) layer;
patterning the backside to define a connector waveguide and a groove in the switching body and to open up an area underneath the comb-drive and springs, including etching regions of the backside to the BOX layer;
removing the BOX layer by etching from the backside; thus, releasing the springs and the comb-drive; and
sputtering metal on the front and back of the wafer, wherein metallization on the backside forms the connector waveguide.
